(19) United States
(12) Patent Application Publication
(10) Pub. No.: US 2026/0161196 A1
(43) Pub. Date: Jun. 11, 2026

(54) DISPLAY DEVICE AND ELECTRONIC DEVICE INCLUDING THE SAME

(71) Applicant: Samsung Display Co., Ltd., Yongin-si (KR)

(72) Inventors: Ki Se LEE, Yongin-si (KR); Ho Sung NAM, Yongin-si (KR); Yeon Woo KIM, Yongin-si (KR); Yong Kwon SOH, Yongin-si (KR); Jun Geun LEE, Yongin-si (KR); Jun Su LEE, Yongin-si (KR)

(21) Appl. No.: 19/267,378

(22) Filed: Jul. 11, 2025

(30) Foreign Application Priority Data
Dec. 11, 2024 (KR) 10-2024-0183955

(51) Int. Cl. G06F 1/16; H04M 1/02

(52) U.S. Cl. CPC G06F 1/1616; G06F 1/1641; H04M 1/0214; H04M 1/0266

(57) ABSTRACT

A display device includes: a display panel including a folding area and a non-folding area on a side of the folding area; a panel support member on the display panel and including a folding portion overlapping the folding area and a non-folding portion overlapping the non-folding area; an adhesive member between the display panel and the panel support member; an elastic member opposite the adhesive member with the panel support member interposed therebetween and overlapping the folding portion; and a step member between the panel support member and the elastic member and overlapping the folding portion, wherein the folding portion includes a plurality of slits and a plurality of bars between the slits, the step member includes a plurality of step patterns apart from each other to form a space between the panel support member and the elastic member, and the space at least partially overlaps the slits.

### CROSS-REFERENCE TO RELATED APPLICATION

The present application claims priority to and the benefit of Korean Patent Application No. 10-2024-0183955, filed on Dec. 11, 2024, in the Korean Intellectual Property Office, the entire disclosure of which is incorporated herein by reference.

### BACKGROUND

### 1. Field

One or more embodiments of the present disclosure relate to a display device and an electronic device including the same.

### 2. Description of the Related Art

As the information society continues to advance, demand for display devices capable of presenting images in various formats has increased. Such display devices may include liquid crystal displays (LCDs), field emission displays (FEDs), and/or light emitting displays. Light emitting displays may include organic light emitting displays that utilize organic light emitting diode (OLED) elements, and inorganic light emitting displays that utilize inorganic light-emitting diode (LED) elements.

To enhance portability while maintaining a large display area, bendable and foldable display devices have recently been developed and commercialized. These devices allow the display area to be bent and/or folded, thereby improving convenience and usability in portable electronic devices.

### SUMMARY

One or more aspects of embodiments of the present disclosure are directed toward a display device with improved impact resistance and an electronic device including the same.

One or more aspects of embodiments of the present disclosure are directed toward a display device with minimized or reduced creases in a folding portion and an electronic device including the same.

However, aspects of the present disclosure are not restricted to those set forth herein. The above and other aspects of the present disclosure will become more apparent to one of ordinary skill in the art to which the present disclosure pertains by referencing the detailed description of the present disclosure provided herein or learning by practice of the presented embodiments of the disclosure.

According to one or more embodiments of the present disclosure, a display device includes: a display panel including a folding area and a non-folding area on (e.g., arranged on) at least one side of the folding area; a panel support member on (e.g., arranged on) the display panel and including a folding portion overlapping the folding area and a non-folding portion overlapping the non-folding area; an adhesive member between (e.g., arranged between) the display panel and the panel support member; an elastic member opposite (e.g., arranged opposite) the adhesive member with the panel support member interposed therebetween and overlapping the folding portion; and a step member between (e.g., arranged between) the panel support member and the elastic member and overlapping the folding portion, wherein the folding portion includes a plurality of slits and a plurality of bars arranged between (e.g., each respectively arranged between) the slits, the step member includes a plurality of step patterns spaced and/or apart (e.g., space apart) from each other to form a space between the panel support member and the elastic member, and the space at least partially overlaps the slits.

In one or more embodiments, the step member includes a step portion overlapping the folding portion and a support portion overlapping the non-folding portion.

In one or more embodiments, a width of the support portion is greater than a width of the step portion.

In one or more embodiments, each of the slits includes a first portion and a second portion arranged on one side of the first portion, the first portion overlaps the step patterns, and the second portion does not overlap the step patterns.

In one or more embodiments, the slits include first slits and second slits arranged parallel to each other in a first direction, each of the first slits and the second slits includes a first portion and a second portion arranged on one side of the first portion, the first slits and the second slits are staggered in a second direction different from the first direction, and the step patterns overlap the first portions of the first slits but do not overlap the first portions of the second slits and do not overlap the second portions of the first slits but overlap the second portions of the second slits.

In one or more embodiments, the step patterns extend in a different direction from the slits.

In one or more embodiments, each of the step patterns includes long sides located in a direction in which the step patterns extend and short sides connected to the long sides, and a length of each of the short sides of the step patterns is smaller than a length of each of the slits in a direction in which the slits extend.

In one or more embodiments, the step patterns are island-type (kind) patterns.

In one or more embodiments, the space is connected to the slits.

In one or more embodiments, the adhesive member overlaps the slits.

In one or more embodiments, the step member is formed by plating or deposition.

According to one or more embodiments of the present disclosure, a display device includes: a display panel including a folding area and a non-folding area on (e.g., arranged on) at least one side of the folding area; a panel support member on (e.g., arranged on) the display panel and including a folding portion overlapping the folding area and a non-folding portion overlapping the non-folding area; an adhesive member between (e.g., arranged between) the display panel and the panel support member; and an elastic member opposite (e.g., arranged opposite) the adhesive member with the panel support member interposed therebetween and overlapping the folding portion, wherein the folding portion includes a plurality of slits and a plurality of bars arranged between (e.g., each respectively arranged between) the slits, the elastic member includes an elastic layer and an adhesive layer between (e.g., arranged between) the elastic layer and the panel support member, the adhesive layer includes a plurality of step patterns spaced apart from each other to form a space between the panel support member and the elastic layer, and the space at least partially overlaps the slits.

In one or more embodiments, each of the slits includes a first portion and a second portion arranged on one side of the first portion, the first portion overlaps the step patterns, and the second portion does not overlap the step patterns.

In one or more embodiments, the space is connected to the slits.

In one or more embodiments, the adhesive member overlaps the slits.

According to one or more embodiments of the present disclosure, a display device includes: a display panel including a folding area and a non-folding area on (e.g., arranged on) at least one side of the folding area; a panel support member on (e.g., arranged on) the display panel and including a folding portion overlapping the folding area and a non-folding portion overlapping the non-folding area; an adhesive member between (e.g., arranged between) the display panel and the panel support member; and an elastic member opposite (e.g., arranged opposite) the adhesive member with the panel support member interposed therebetween and overlapping the folding portion, wherein the folding portion includes a plurality of slits and a plurality of bars arranged between (e.g., each respectively arranged between) the slits, the elastic member includes a plurality of holes penetrating the elastic member, and the holes at least partially overlap the slits.

In one or more embodiments, the holes are connected to the slits.

According to one or more embodiments of the present disclosure, an electronic device includes a display device and a processor, wherein the display device includes: a display panel including a folding area and a non-folding area on (e.g., arranged on) at least one side of the folding area; a panel support member on (e.g., arranged on) the display panel and including a folding portion overlapping the folding area and a non-folding portion overlapping the non-folding area; an adhesive member between (e.g., arranged between) the display panel and the panel support member; an elastic member opposite (e.g., arranged opposite) the adhesive member with the panel support member interposed therebetween and overlapping the folding portion; and a step member between (e.g., arranged between) the panel support member and the elastic member and overlapping the folding portion, wherein the folding portion includes a plurality of slits and a plurality of bars arranged between (e.g., each respectively arranged between) the slits, the step member includes a plurality of step patterns spaced apart from each other to form a space between the panel support member and the elastic member, and the space at least partially overlaps the slits.

According to one or more embodiments of the present disclosure, an electronic device includes a display device and a processor, wherein the display device includes: a display panel including a folding area and a non-folding area on (e.g., arranged on) at least one side of the folding area; a panel support member on (e.g., arranged on) the display panel and including a folding portion overlapping the folding area and a non-folding portion overlapping the non-folding area; an adhesive member between (e.g., arranged between) the display panel and the panel support member; and an elastic member opposite (e.g., arranged opposite) the adhesive member with the panel support member interposed therebetween and overlapping the folding portion, wherein the folding portion includes a plurality of slits and a plurality of bars arranged between (e.g., each respectively arranged between) the slits, the elastic member includes an elastic layer and an adhesive layer between (e.g., arranged between) the elastic layer and the panel support member, the adhesive layer includes a plurality of step patterns spaced apart from each other to form a space between the panel support member and the elastic layer, and the space at least partially overlaps the slits.

According to one or more embodiments of the present disclosure, an electronic device includes a display device and a processor, wherein the display device includes: a display panel including a folding area and a non-folding area on (e.g., arranged on) at least one side of the folding area; a panel support member on (e.g., arranged on) the display panel and including a folding portion overlapping the folding area and a non-folding portion overlapping the non-folding area; an adhesive member between (e.g., arranged between) the display panel and the panel support member, and an elastic member opposite (e.g., arranged opposite) the adhesive member with the panel support member interposed therebetween and overlapping the folding portion, wherein the folding portion includes a plurality of slits and a plurality of bars arranged between (e.g., each respectively arranged between) the slits, the elastic member includes a plurality of holes penetrating the elastic member, and the holes at least partially overlap the slits.

According to a display device and an electronic device including the same of one or more embodiments of the present disclosure, impact resistance may be improved. For examples, the display device and the electronic device including the same may exhibit enhanced impact resistance. This improvement is achieved through the integration of a multi-layered structure including a display panel, a panel support member, an adhesive member, and an elastic member. In particular, the inclusion of slits and bars in the folding portion of the panel support member, in combination with step patterns or holes in the elastic member or adhesive layer, allows for controlled deformation and stress dispersion during folding and/or mechanical impact. The space formed between the step patterns and the adjacent layers acts as a buffer zone and air pathway, absorbing and redistributing external forces, thereby reducing the likelihood of damage to the display panel and internal components.

According to a display device and an electronic device including the same of one or more embodiments of the present disclosure, creases in a folding portion thereof may be minimized or reduced. For example, the display device and the electronic device including the same may also exhibit reduced or minimized crease formation in the folding portion. This is facilitated by the strategic arrangement of slits and bars in the folding area, which guide the bending motion along predefined paths, and by the presence of step patterns or holes that provide localized flexibility and strain relief and air pathway. The partial overlap of these features with the slits should ensure that the folding stress is distributed more evenly across the structure, thereby preventing or reducing the concentration of stress that typically leads to visible creases. As a result, the display device may maintain a smoother appearance and improved durability over repeated folding cycles.

However, the effects and aspects of the present disclosure are not restricted to embodiments set forth herein. The above and other effects of the present disclosure will become more apparent to one of daily skill in the art to which the present disclosure pertains by referencing the appended claims and equivalents thereof or by practice of the presented embodiments of the disclosure.

### BRIEF DESCRIPTION OF THE DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. Above and/or other aspects will become apparent and more readily appreciated from the following description of example embodiments, taken in conjunction with the accompanying drawings, in which:

FIG. 1 is a perspective view illustrating an unfolded state of a display device according to one or more embodiments of the present disclosure;

FIG. 2 is a perspective view illustrating a folded state of a display device according to one or more embodiments of the present disclosure;

FIG. 3 is a perspective view illustrating an unfolded state of a display device according to one or more embodiments of the present disclosure;

FIG. 4 is a perspective view illustrating a folded state of the display device according to the embodiment of FIG. 3;

FIG. 5 is a cross-sectional view of a display device according to one or more embodiments of the present disclosure;

FIG. 6 is a cross-sectional view of an example of a display panel according to one or more embodiments of the present disclosure;

FIG. 7 is a plan view of a panel support member according to one or more embodiments of the present disclosure;

FIG. 8 is a rear view illustrating the panel support member and a step member according to an embodiment in part A of FIG. 7;

FIG. 9 is an enlarged view of part B of FIG. 8 according to one or more embodiments of the present disclosure;

FIG. 10 is a cross-sectional view taken along the line X1-X1′ of FIG. 8 according to one or more embodiments of the present disclosure;

FIG. 11 is a cross-sectional view taken along the line X2-X2′ of FIG. 8 according to one or more embodiments of the present disclosure;

FIG. 12 is a cross-sectional view taken along the line X3-X3′ of FIG. 8 according to one or more embodiments of the present disclosure;

FIG. 13 is a cross-sectional view illustrating a process of bonding a display panel to a set member in a process of manufacturing a display device according to a first comparative example of the present disclosure;

FIG. 14 is a cross-sectional view illustrating a process of bonding a display panel to a set member in a process of manufacturing a display device according to a second comparative example of the present disclosure;

FIG. 15 is a cross-sectional view illustrating a process of bonding a display panel to a set member in a process of manufacturing a display device according to the embodiment of FIG. 8;

FIG. 16 is an image of a folding portion of the display device according to the first comparative example of the present disclosure;

FIG. 17 is an image of a folding portion of the display device according to the second comparative example of the present disclosure;

FIG. 18 is an image of a folding portion of the display device according to the embodiment of FIG. 8;

FIG. 19 is a rear view illustrating a panel support member and a step member of a display device according to one or more embodiments of the present disclosure;

FIG. 20 is a cross-sectional view illustrating a second adhesive member, a panel support member, and an elastic member of a display device according to one or more embodiments of the present disclosure;

FIG. 21 is a rear view illustrating a panel support member and a step member of a display device according to one or more embodiments of the present disclosure;

FIG. 22 is a rear view illustrating a panel support member and an adhesive layer of a step member of a display device according to one or more embodiments of the present disclosure;

FIG. 23 is a cross-sectional view illustrating a second adhesive member, a panel support member, and an elastic member of a display device according to one or more embodiments of the present disclosure;

FIG. 24 is a rear view illustrating an example of the panel support member and the elastic member of the display device according to the embodiment of FIG. 23;

FIG. 25 is a rear view illustrating an example of the panel support member and the elastic member of the display device according to the embodiment of FIG. 23;

FIG. 26 is a block diagram of an electronic device according to one or more embodiments of the present disclosure; and

FIG. 27 is a schematic diagram of electronic devices according to various embodiments of the present disclosure.

### DETAILED DESCRIPTION

The present disclosure will now be described more fully hereinafter with reference to the accompanying drawings, in which example embodiments of the disclosure are shown. This disclosure may, however, be embodied in different forms and should not be construed as limited to the embodiments set forth herein. Rather, these embodiments are provided so that this disclosure will be thorough and complete, and will filly convey the scope of the present disclosure to those skilled in the art.

It will also be understood that if (e.g., when) a layer is referred to as being “on” another layer or substrate, it may be directly on the other layer or substrate, or one or more intervening layers may also be present therebetween. In contrast, “directly on” may refer to that there are no additional intervening elements or layers between the element or layer and the another element or layer. The same or like reference numbers indicate the same or like components throughout the disclosure, and duplicative descriptions thereof may not be provided for conciseness.

Hereinafter, one or more embodiments of the present disclosure will be described in more detail with reference to the accompanying drawings. Various embodiments may be practiced individually or in combination.

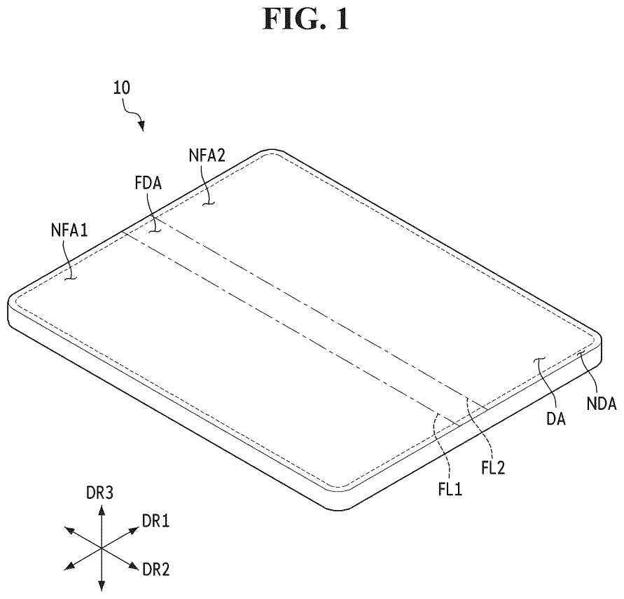

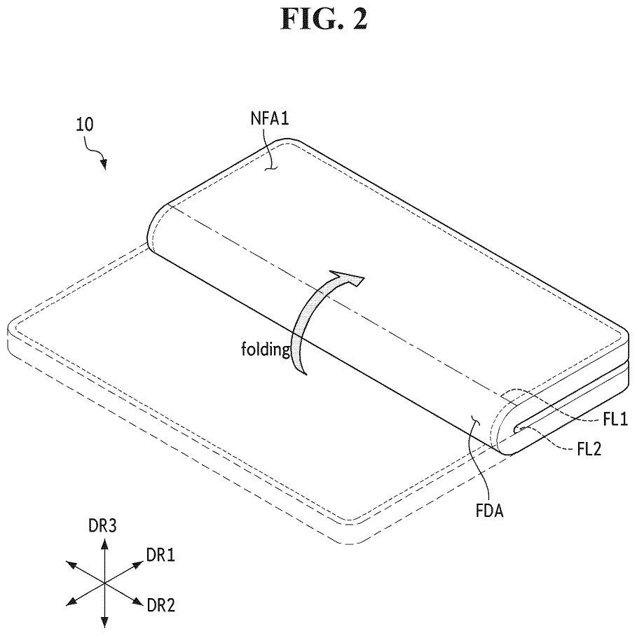

FIG. 1 is a perspective view illustrating an unfolded state of a display device 10 according to one or more embodiments of the present disclosure. FIG. 2 is a perspective view illustrating a folded state of the display device 10 according to one or more embodiments.

Referring to FIG. 1 and FIG. 2, FIG. 1 illustrates a first state in which the display device 10 is not folded at folding lines FL1 and FL2, and FIG. 2 illustrates a second state in which the display device 10 is folded at the folding lines FL1 and FL2.

The display device 10 according to one or more embodiments is a device for displaying moving images or still images. The display device 10 may be used as a display screen in portable electronic devices such as mobile phones, smartphones, tablet personal computers (PCs), smart watches, watch phones, mobile communication terminals, electronic notebooks, electronic books, portable multimedia players (PMPs), navigation devices, and/or ultra-mobile PCs (UMPCs), as well as in one or more suitable products such as televisions, notebook computers, monitors, billboards, and/or Internet of things (IoT) devices.

In the drawings, a first direction DR1 and a second direction DR2 are horizontal directions intersecting each other. For example, the first direction DR1 and the second direction DR2 may be orthogonal to each other. In addition, a third direction DR3 may intersect the first direction DR1 and the second direction DR2, for example, may be a vertical direction orthogonal to the first direction DR1 and the second direction DR2. Unless otherwise defined, in the present disclosure, a direction indicated by an arrow of each of the first through third directions DR1 through DR3 may be referred to as one side, and the opposite direction may be referred to as the other side. In addition, in the present disclosure, “on”, “upper side”, “upper”, “top”, and “upper surface” refer to a direction or a spatial relationship in which the arrow of the third direction DR3 points in the drawings, and “under”, “lower side”, “lower”, “bottom”, and “lower surface” refer to a direction or a spatial relationship opposite to the direction in which the arrow of the third direction DR3 points in the drawings.

In the drawings, the first direction DR1 may be a direction parallel to a side of the display device 10 in plan view, for example, may be a transverse direction of the display device 10. The second direction DR2 may be a direction parallel to another side in contact with the aforementioned side of the display device 10 in plan view, for example, may be a longitudinal direction of the display device 10. The third direction DR3 may be a thickness direction of the display device 10.

In one or more embodiments, the display device 10 may have a quadrilateral shape such as a rectangle in plan view. Each corner of the display device 10 may be right-angled or rounded in plan view. A front surface of the display device 10 may include two short sides in the first direction DR1 and two long sides in the second direction DR2.

The display device 10 may include a display area DA and a non-display area NDA. A shape of the display area DA may follow the shape of the display device 10 in plan view. For example, if (e.g., when) the display device 10 is rectangular in plan view, the display area DA may also be rectangular in plan view.

The display area DA may be an area which includes a plurality of pixels to display an image. The non-display area NDA may be an area which does not include pixels and thus does not display an image. The non-display area NDA may be arranged around the display area DA. In one or more embodiments, the non-display area NDA may surround (e.g., be around) the display area DA, but embodiments of the present disclosure are not limited thereto. In one or more embodiments, the display area DA may also be partially surrounded by the non-display area NDA.

The display device 10 may maintain the first state which is the unfolded state or the second state which is the folded state. In one or more embodiments, the display device 10 may be folded in an in-folding manner so that portions of the display area DA face each other as illustrated in FIG. 2. In these embodiments, portions of the front surface of the display device 10 may face each other if (e.g., when) the display device 10 is folded. In one or more embodiments, the display device 10 may be folded in an out-folding manner so that portions of a back surface of the display device 10 face each other.

The display device 10 may include a folding area FDA, a first non-folding area NFA1, and a second non-folding area NFA2. The folding area FDA may be an area where the display device 10 is bent or folded. The first non-folding area NFA1 and the second non-folding area NFA2 may each be an area where the display device 10 is not bent or folded. In one or more embodiments, the first non-folding area NFA1 and the second non-folding area NFA2 may each be a flat area of the display device 10.

The first non-folding area NFA1 may be arranged on a side, e.g., a left side of the folding area FDA. The second non-folding area NFA2 may be arranged on the other side, e.g., a right side of the folding area FDA. The folding area FDA may be an area which is defined by a first folding line FL1 and a second folding line FL2 and an area in which the display device 10 is bent with a set or predetermined curvature. The first folding line FL1 may be a boundary between the folding area FDA and the first non-folding area NFA1, and the second folding line FL2 may be a boundary between the folding area FDA and the second non-folding area NFA2.

In one or more embodiments, the first folding line FL1 and the second folding line FL2 may each extend in the second direction DR2 as illustrated in FIG. 1 and FIG. 2. In these embodiments, the display device 10 may be folded with respect to the second direction DR2. Therefore, a length of the display device 10 in the first direction DR1 can be reduced by about half when the display device 10 is folded, and thus a user may easily carry the display device 10.

The first non-folding area NFA1 may be arranged on a side, e.g., the left side of the folding area FDA. The second non-folding area NFA2 may be arranged on the other side, e.g., the right side of the folding area FDA. Here, the left side may refer to one side in the first direction DR1, and the right side may refer to the other side in the first direction DR1.

When the first folding line FL1 and the second folding line FL2 extend in the second direction DR2 as illustrated in FIG. 1 and FIG. 2, a length of the folding area FDA in the second direction DR2 may be greater than a length of the folding area FDA in the first direction DR1. In addition, a length of the first non-folding area NFA1 in the second direction DR2 may be greater than a length of the first non-folding area NFA1 in the first direction DR1. A length of the second non-folding area NFA2 in the second direction DR2 may be greater than a length of the second non-folding area NFA2 in the first direction DR1.

Each of the display area DA and the non-display area NDA may overlap at least one of the folding area FDA, the first non-folding area NFA1, or the second non-folding area NFA2. In FIG. 1 and FIG. 2, each of the display area DA and the non-display area NDA overlaps the folding area FDA, the first non-folding area NFA1, and the second non-folding area NFA2.

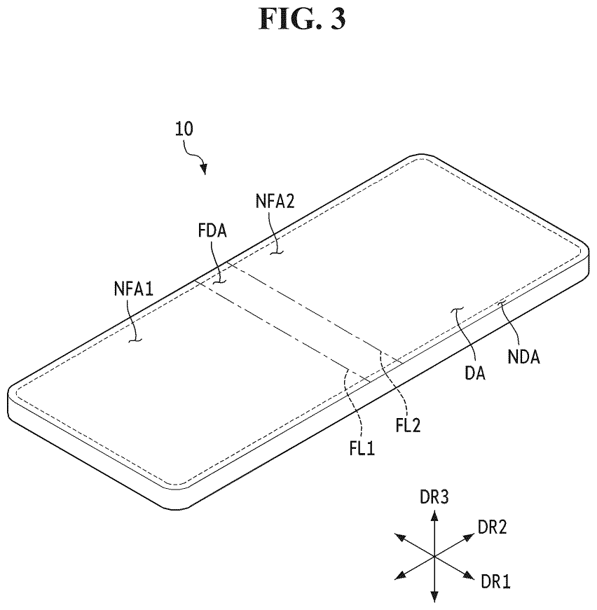

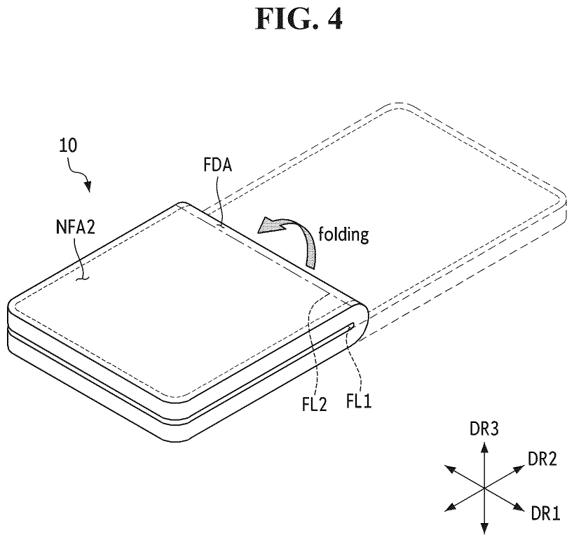

FIG. 3 is a perspective view illustrating an unfolded state of a display device 10 according to one or more embodiments of the present disclosure. FIG. 4 is a perspective view illustrating a folded state of the display device 10 according to one or more embodiments.

Referring to FIG. 3 and FIG. 4 in addition to FIG. 1 and FIG. 2, FIG. 3 illustrates a first state in which the display device 10 is not folded at folding lines FL1 and FL2, and FIG. 4 illustrates a second state in which the display device 10 is folded at the folding lines FL1 and FL2.

The embodiment of FIGS. 3 and 4 is different from the embodiment of FIGS. 1 and 2 only in that a first folding line FL1 and a second folding line FL2 each extend in the first direction DR1, and the display device 10 is folded in the second direction DR2 so that a length of the display device 10 in the second direction DR2 is reduced by about half when the display device 10 is folded. Therefore, in FIGS. 3 and 4, redundant descriptions of elements and features substantially identical to those of the embodiment of FIGS. 1 and 2 will not be provided for conciseness.

In the first state in which the display device 10 is unfolded, long sides of the display device 10 may extend along the second direction DR2, and short sides of the display device 10 may extend along the first direction DR1.

The first folding line FL1 and the second folding line FL2 may each extend in the first direction DR1 as illustrated in FIGS. 3 and 4. In this regard, the display device 10 may be folded with respect to the first direction DR1.

A first non-folding area NFA1 may be arranged on a side, e.g., a lower side of a folding area FDA. A second non-folding area NFA2 may be arranged on the other side, e.g., an upper side of the folding area FDA. Here, the upper side may refer to one side in the second direction DR2, and the lower side may refer to the other side in the second direction DR2.

When the first folding line FL1 and the second folding line FL2 extend in the first direction DR1 as illustrated in FIGS. 3 and 4, a length of the folding area FDA in the first direction DR1 may be greater than a length of the folding area FDA in the second direction DR2. In addition, a length of the first non-folding area NFA1 in the second direction DR2 may be greater than a length of the first non-folding area NFA1 in the first direction DR1. A length of the second non-folding area NFA2 in the second direction DR2 may be greater than a length of the second non-folding area NFA2 in the first direction DR1.

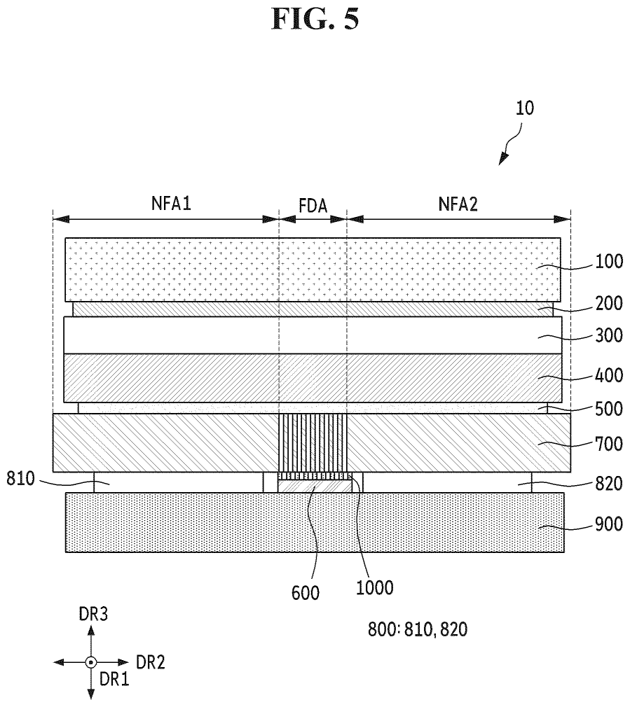

FIG. 5 is a cross-sectional view of a display device 10 according to one or more embodiments of the present disclosure.

Referring to FIG. 5, the display device 10 according to one or more embodiments may include an upper protective member 100, a window member 200, a first adhesive member 300, a display panel 400, a second adhesive member 500, a panel support member 700, an elastic member 600, a third adhesive member 800, a lower functional member 900, and a step member 1000.

The display panel 400 may be a panel that displays an image. The display panel 400 may be an organic light emitting display panel including an organic light emitting layer, a quantum dot light emitting display panel including a quantum dot light emitting layer, an inorganic light emitting display panel using an inorganic semiconductor element as a light emitting element, or a micro-light emitting display panel using a micro-light emitting diode as a light emitting element. One or more embodiments in which the display panel 400 is an organic light emitting display panel will be mainly described in more detail herein, but the present disclosure is not limited to these embodiments.

The window member 200 may be attached onto a front surface of the display panel 400 by the first adhesive member 300. The window member 200 may be made of a transparent material and may be, for example, glass or plastic. For example, in one or more embodiments, the window member 200 may be ultra-thin glass (UTG) having a thickness of 0.1 mm or less or may be a transparent polyimide film.

The first adhesive member 300 may be arranged on a back surface of the window member 200. For example, the first adhesive member 300 may be arranged between the window member 200 and the display panel 400. The window member 200 and the display panel 400 may be bonded to each other through the first adhesive member 300. The first adhesive member 300 may include an adhesive material such as a pressure sensitive adhesive (PSA) or an optically clear adhesive (OCA). In one or more embodiments, the first adhesive member 300 may include an acrylic adhesive material.

The upper protective member 100 may be arranged on a front surface of the window member 200. The upper protective member 100 may be attached to the front surface of the window member 200. The upper protective member 100 may perform at least one function selected from among the functions of shatter prevention, shock absorption, scratch prevention, fingerprint prevention, and glare prevention of the window member 200.

In one or more embodiments, a light blocking pattern may be formed on a back surface of the upper protective member 100. The light blocking pattern may be arranged at or adjacent to an edge of the upper protective member 100. The light blocking pattern may include a light blocking material that can block light. For example, in one or more embodiments, the light blocking pattern may be an inorganic black pigment such as carbon black, an organic black pigment, or an opaque metal material.

In one or more embodiments, a cover window may be further arranged on the upper protective member 100. The cover window may be a protective film for protecting the display device 10 from external impact. The cover window may be attached to the display device 10 by an adhesive member or may be removed from the display device 10. For example, in one or more embodiments, the cover window may be a changeable window. In one or more embodiments, the cover window may include, but is not limited to, at least one of flexible polyethylene terephthalate (PET) or thermoplastic polyurethane (TPU).

The panel support member 700 may be arranged on a back surface of the display panel 400. The panel support member 700 may be a rigid member whose shape or volume is not easily changed by external pressure. Because the panel support member 700 is a rigid member whose shape or volume is not easily changed by external pressure, it may support the display panel 400.

In one or more embodiments, the panel support member 700 may be a polymer including carbon fibers or glass fibers. In these embodiments, because the panel support member 700 is made of a polymer including carbon fibers or glass fibers, if (e.g., when) a digitizer is included in the lower functional member 900, the panel support member 700 may allow a magnetic field or electromagnetic signal of the digitizer to pass therethrough. Therefore, the panel support member 700 that can support the display panel 400 while not lowering the touch sensitivity of the digitizer may be provided.

In one or more embodiments, the panel support member 700 may be a metal plate. For example, in one or more embodiments, the panel support member 700 may be a metal plate made of metal or a metal alloy. The panel support member 700 may include, but is not limited to, copper (Cu), aluminum (Al), stainless steel (SUS), and/or an alloy thereof.

The panel support member 700 may include a grid pattern in a folding area FDA so that it can be easily bent in the folding area FDA. Because the panel support member 700 includes the grid pattern in the folding area FDA, it can be easily bent if (e.g., when) the display device 10 is folded.

The second adhesive member 500 may be arranged on the back surface of the display panel 400. For example, the second adhesive member 500 may be arranged between the panel support member 700 and the display panel 400. The panel support member 700 and the display panel 400 may be bonded to each other through the second adhesive member 500. The second adhesive member 500 may include an adhesive material such as a pressure sensitive adhesive or an optically clear adhesive. In one or more embodiments, the second adhesive member 500 may include an acrylic adhesive material.

The elastic member 600 may be arranged on a back surface of the panel support member 700. The elastic member 600 may overlap the folding area FDA. The elastic member 600 may be arranged on a same layer as the third adhesive member 800. The elastic member 600 may be arranged between a (3-1)^{th} adhesive member 810 and a (3-2)^{th} adhesive member 820. The elastic member 600 may prevent or reduce the grid pattern of the panel support member 700 from being visible from the outside and may prevent or reduce foreign substances from penetrating into the grid pattern and damaging the display panel 400. The elastic member 600 may include a material having flexibility and elasticity to reduce the folding stress of the display device 10. For example, in one or more embodiments, the elastic member 600 may include thermoplastic polyurethane (TPU).

The step member 1000 may be arranged between the elastic member 600 and the panel support member 700. The step member 1000 may overlap the folding area FDA and the elastic member 600. The step member 1000 may be arranged on a same layer as the third adhesive member 800. The step member 1000 may be arranged between the (3-1)^{th} adhesive member 810 and the (3-2)^{th} adhesive member 820. The step member 1000 may form a space between the elastic member 600 and the panel support member 700 to provide a passage (e.g., an air path) through which air inside the grid pattern can escape to the outside if (e.g., when) the display panel 400 and the panel support member 700 are bonded together. Accordingly, creases may be minimized or reduced in a folding portion of the display device 10.

The lower functional member 900 may perform one or more suitable functions by including at least one member. For example, in one or more embodiments, the lower functional member 900 may include at least one of a light blocking layer for absorbing light incident from the outside, a buffer layer for absorbing external impact, or a heat dissipation layer for efficiently dissipating the heat of the display panel 400. In one or more embodiments, the lower functional member 900 may include a digitizer member (e.g., a digitizer) for sensing the approach or touch of an electronic pen such as a stylus pen that supports electromagnetic resonance (EMR). In one or more embodiments, the lower functional member 900 may include a waterproof and dustproof member for preventing or reducing penetration of moisture and/or dust.

The third adhesive member 800 may be arranged on the back surface of the panel support member 700. For example, the third adhesive member 800 may be arranged between the panel support member 700 and the lower functional member 900. The panel support member 700 and the lower functional member 900 may be bonded to each other through the third adhesive member 800. The third adhesive member 800 may include an adhesive material such as a pressure sensitive adhesive or an optically clear adhesive. In one or more embodiments, the third adhesive member 800 may include an acrylic adhesive material.

In one or more embodiments, the third adhesive member 800 may include the (3-1)^{th} adhesive member 810 overlapping a first non-folding area NFA1 and the (3-2)^{th} adhesive member 820 overlapping a second non-folding area NFA2. The (3-1)^{th} adhesive member 810 and the (3-2)^{th} adhesive member 820 may be spaced apart from each other with the elastic member 600 and the step member 1000 interposed therebetween.

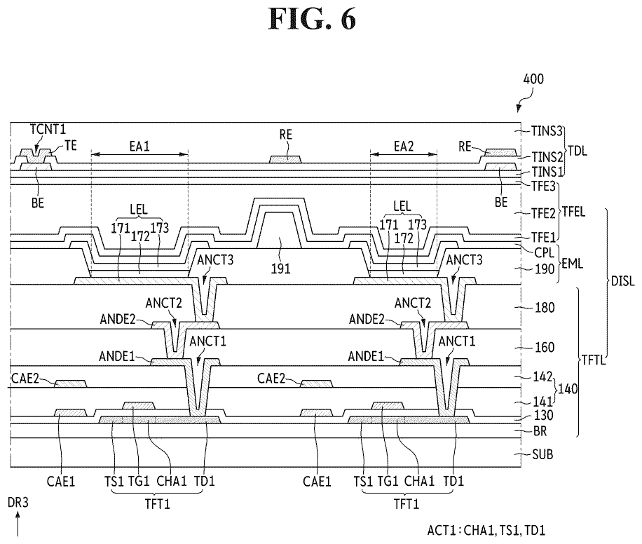

FIG. 6 is a cross-sectional view of an example of a display panel 400 according to one or more embodiments of the present disclosure.

Referring to FIG. 6, the display panel 400 may include a substrate SUB, a display layer DISL arranged on the substrate SUB, and a touch sensing layer TDL arranged on the display layer DISL. The display layer DISL may include a thin-film transistor layer TFTL, a light emitting element layer EML, and an encapsulation layer TFEL.

The thin-film transistor layer TFTL may be arranged on the substrate SUB. The thin-film transistor layer TFTL may include a barrier layer BR, thin-film transistors TFT1, first capacitor electrodes CAE1, second capacitor electrodes CAE2, first anode connection electrodes ANDE1, second anode connection electrodes ANDE2, a gate insulating layer 130, a first interlayer insulating layer 141, a second interlayer insulating layer 142, a first planarization layer 160, and a second planarization layer 180.

The substrate SUB may be made of an insulating material such as a polymer resin. For example, in one or more embodiments, the substrate SUB may be made of polyimide. The substrate SUB may be a flexible substrate that can be bent, folded, or rolled.

The barrier layer BR may be arranged on the substrate SUB. The barrier layer BR is a layer for protecting thin-film transistors of the thin-film transistor layer TFTL and light emitting layers 172 of the light emitting element layer EML from moisture introduced through the substrate SUB which may be vulnerable to moisture penetration. In one or more embodiments, the barrier layer BR may be composed of a plurality of inorganic layers stacked alternately. For example, in one or more embodiments, the barrier layer BR may be a multilayer in which one or more inorganic layers selected from among a silicon nitride layer, a silicon oxynitride layer, a silicon oxide layer, a titanium oxide layer, and an aluminum oxide layer are alternately stacked.

The thin-film transistors TFT1 may be arranged on the barrier layer BR. An active layer ACT1 of each of the thin-film transistors TFT1 may be arranged on the barrier layer BR. The active layer ACT1 of each of the thin-film transistors TFT1 may include polycrystalline silicon, monocrystalline silicon, low-temperature polycrystalline silicon, amorphous silicon, or an oxide semiconductor.

The active layer ACT1 may include a channel region CHA1, a source region TS1, and a drain region TD1. The channel region CHA1 may be a region overlapped by a gate electrode TG1 in the third direction DR3 which is a thickness direction of the substrate SUB. The source region TS1 may be arranged on a side of the channel region CHA1, and the drain region TD1 may be arranged on the other side of the channel region CHA1. The source region TS1 and the drain region TD1 may be regions not overlapped by the gate electrode TG1 in the third direction DR3. The source region TS1 and the drain region TD1 may be regions formed to have conductivity by doping a silicon semiconductor or an oxide semiconductor with ions or impurities.

The gate insulating layer 130 may be arranged on the active layers ACT1 of the thin-film transistors TFT1. The gate insulating layer 130 may be made of an inorganic layer, for example, a silicon nitride layer, a silicon oxynitride layer, a silicon oxide layer, a titanium oxide layer, or an aluminum oxide layer.

The gate electrodes TG1 of the thin-film transistors TFT1 and the first capacitor electrodes CAE1 may be arranged on the gate insulating layer 130. The gate electrode TG1 may overlap the channel region CHA1 in the third direction DR3. Although the gate electrode TG1 and the first capacitor electrode CAE1 are spaced apart from each other in FIG. 6, in one or more embodiments, they may also be connected and integrally formed with each other. Each of the gate electrodes TG1 and the first capacitor electrodes CAE1 may be a single layer or a multilayer made of any one or more selected from among molybdenum (Mo), aluminum (Al), chromium (Cr), gold (Au), titanium (Ti), nickel (Ni), neodymium (Nd), copper (Cu), and alloys thereof.

The first interlayer insulating layer 141 may be arranged on the gate electrodes TG1 of the thin-film transistors TFT1 and the first capacitor electrodes CAE1. The first interlayer insulating layer 141 may be made of an inorganic layer, for example, a silicon nitride layer, a silicon oxynitride layer, a silicon oxide layer, a titanium oxide layer, or an aluminum oxide layer. In one or more embodiments, the first interlayer insulating layer 141 may be composed of a plurality of inorganic layers.

The second capacitor electrodes CAE2 may be arranged on the first interlayer insulating layer 141. The second capacitor electrodes CAE2 may correspondingly overlap the first capacitor electrodes CAE1 in the third direction DR3. In one or more embodiments, if (e.g., when) the gate electrode TG1 and the first capacitor electrode CAE1 are integrally formed, the second capacitor electrode CAE2 may overlap the gate electrode TG1 in the third direction DR3. Because the first interlayer insulating layer 141 has a set or predetermined dielectric constant, corresponding capacitors may be formed by the first capacitor electrodes CAE1, the second capacitor electrodes CAE2, and the first interlayer insulating layer 141 arranged between them. Each of the second capacitor electrodes CAE2 may be a single layer or a multilayer made of any one or more selected from among molybdenum (Mo), aluminum (Al), chromium (Cr), gold (Au), titanium (Ti), nickel (Ni), neodymium (Nd), copper (Cu), and alloys thereof.

The second interlayer insulating layer 142 may be arranged on the second capacitor electrodes CAE2. The second interlayer insulating layer 142 may be made of an inorganic layer, for example, a silicon nitride layer, a silicon oxynitride layer, a silicon oxide layer, a titanium oxide layer, or an aluminum oxide layer. In one or more embodiments, the second interlayer insulating layer 142 may be composed of a plurality of inorganic layers.

The first anode connection electrodes ANDE1 may be arranged on the second interlayer insulating layer 142. Each of the first anode connection electrodes ANDE1 may be connected to the drain region TD1 of a corresponding thin-film transistor TFT1 through a first connection contact hole ANCT1 penetrating the gate insulating layer 130, the first interlayer insulating layer 141, and the second interlayer insulating layer 142. Each of the first anode connection electrodes ANDE1 may be a single layer or a multilayer made of any one or more selected from among molybdenum (Mo), aluminum (Al), chromium (Cr), gold (Au), titanium (Ti), nickel (Ni), neodymium (Nd), copper (Cu), and alloys thereof.

The first planarization layer 160 may be arranged on the first anode connection electrodes ANDE1 to flatten steps due to the thin-film transistors TFT1. The first planarization layer 160 may be made of an organic layer such as an acryl resin, an epoxy resin, a phenolic resin, a polyamide resin, or a polyimide resin.

The second anode connection electrodes ANDE2 may be arranged on the first planarization layer 160. Each of the second anode connection electrodes ANDE2 may be connected to a corresponding first anode connection electrode ANDE1 through a second connection contact hole ANCT2 penetrating the first planarization layer 160. Each of the second anode connection electrodes ANDE2 may be a single layer or a multilayer made of any one or more selected from among molybdenum (Mo), aluminum (Al), chromium (Cr), gold (Au), titanium (Ti), nickel (Ni), neodymium (Nd), copper (Cu), and alloys thereof.

The second planarization layer 180 may be arranged on the second anode connection electrodes ANDE2. The second planarization layer 180 may be made of an organic layer such as an acryl resin, an epoxy resin, a phenolic resin, a polyamide resin, or a polyimide resin.

The light emitting element layer EML including light emitting elements LEL and a bank 190 may be arranged on the second planarization layer 180. Each of the light emitting elements LEL includes a pixel electrode 171, a light emitting layer 172, and a common electrode 173.

The pixel electrode 171 may be arranged on the second planarization layer 180. The pixel electrode 171 may be connected to a corresponding second anode connection electrode ANDE2 through a third connection contact hole ANCT3 penetrating the second planarization layer 180.

In a top emission structure in which light is emitted from the light emitting layer 172 toward the common electrode 173, the pixel electrode 171 may be made of a metal material having high reflectivity, such as a stacked structure (Ti/Al/Ti) of aluminum and titanium, a stacked structure (ITO/Al/ITO) of aluminum and indium tin oxide, a stacked structure (ITO/Ag/ITO) of silver and indium tin oxide, an APC alloy, or a stacked structure (ITO/APC/ITO) of an APC alloy and indium tin oxide. The APC alloy is an alloy of silver (Ag), palladium (Pd), and copper (Cu).

The bank 190 may be formed on the second planarization layer 180 to separate the pixel electrodes 171 so as to define emission portions EA1 and EA2. The bank 190 may cover edges of the pixel electrodes 171. The bank 190 may be made of an organic layer such as an acryl resin, an epoxy resin, a phenolic resin, a polyamide resin, or a polyimide resin.

Each of a first emission portion EA1 and a second emission portion EA2 is an area in which the pixel electrode 171, the light emitting layer 172, and the common electrode 173 are sequentially stacked so that holes from the pixel electrode 171 and electrons from the common electrode 173 recombine together in the light emitting layer 172 to emit light.

The light emitting layer 172 may be arranged on the pixel electrode 171 and the bank 190. The light emitting layer 172 may include an organic material to emit light of a set or predetermined color. For example, in one or more embodiments, the light emitting layer 172 may include a hole transporting layer, an organic material layer, and an electron transporting layer.

The common electrode 173 may be arranged on the light emitting layer 172. The common electrode 173 may cover the light emitting layer 172. The common electrode 173 may be a common layer formed commonly in the first emission portion EA1 and the second emission portion EA2.

In the top emission structure, the common electrode 173 may be made of a transparent conductive material (TCO) that can transmit light, such as indium tin oxide (ITO) and/or indium zinc oxide (IZO), or a semi-transmissive conductive material such as magnesium (Mg), silver (Ag), or an alloy of Mg and Ag. When the common electrode 173 is made of a semi-transmissive conductive material, light output efficiency may be increased by a microcavity.

A spacer 191 may be arranged on the bank 190. The spacer 191 may support a mask during a process of manufacturing the light emitting layers 172. The spacer 191 may be made of an organic layer such as an acryl resin, an epoxy resin, a phenolic resin, a polyamide resin, or a polyimide resin.

In one or more embodiments, the display panel 400 may further include a capping layer CPL arranged on the common electrode 173. The capping layer CPL may include an inorganic material. For example, in one or more embodiments, the capping layer CPL may include at least one of silicon nitride, aluminum nitride, zirconium nitride, titanium nitride, hafnium nitride, tantalum nitride, silicon oxide, aluminum oxide, titanium oxide, tin oxide, cerium oxide, or silicon oxynitride.

The encapsulation layer TFEL may be arranged on the common electrode 173. The encapsulation layer TFEL may include at least one inorganic layer to prevent or reduce oxygen and/or moisture from permeating into the light emitting element layer EML. In addition, the encapsulation layer TFEL may include at least one organic layer to protect the light emitting element layer EML from foreign substances such as dust. For example, in one or more embodiments, the encapsulation layer TFEL may include a first encapsulating inorganic layer TFE1, an encapsulating organic layer TFE2, and a second encapsulating inorganic layer TFE3.

The first encapsulating inorganic layer TFE1 may be arranged on the common electrode 173, the encapsulating organic layer TFE2 may be arranged on the first encapsulating inorganic layer TFE1, and the second encapsulating inorganic layer TFE3 may be arranged on the encapsulating organic layer TFE2. Each of the first encapsulating inorganic layer TFE1 and the second encapsulating inorganic layer TFE3 may be a multilayer in which one or more inorganic layers selected from among a silicon nitride layer, a silicon oxynitride layer, a silicon oxide layer, a titanium oxide layer, and an aluminum oxide layer are alternately stacked. The encapsulating organic layer TFE2 may be an organic layer such as an acryl resin, an epoxy resin, a phenolic resin, a polyamide resin, or a polyimide resin.

The touch sensing layer TDL may be arranged on the encapsulation layer TFEL. The touch sensing layer TDL may include a first touch insulating layer TINS1, connection electrodes BE, a second touch insulating layer TINS2, driving electrodes TE, sensing electrodes RE, and a third touch insulating layer TINS3.

The first touch insulating layer TINS1 may be arranged on the encapsulation layer TFEL. The first touch insulating layer TINS1 may be made of an inorganic layer, for example, a silicon nitride layer, a silicon oxynitride layer, a silicon oxide layer, a titanium oxide layer, or an aluminum oxide layer.

The connection electrodes BE may be arranged on the first touch insulating layer TINS1. Each of the connection electrodes BE may be a single layer or a multilayer made of any one or more selected from among molybdenum (Mo), aluminum (Al), chromium (Cr), gold (Au), titanium (Ti), nickel (Ni), neodymium (Nd), copper (Cu), and alloys thereof.

The second touch insulating layer TINS2 may be arranged on the connection electrodes BE. In one or more embodiments, the second touch insulating layer TINS2 may be made of an inorganic layer, for example, a silicon nitride layer, a silicon oxynitride layer, a silicon oxide layer, a titanium oxide layer, or an aluminum oxide layer. In one or more embodiments, the second touch insulating layer TINS2 may be made of an organic layer such as an acryl resin, an epoxy resin, a phenolic resin, a polyamide resin, or a polyimide resin.

The driving electrodes TE and the sensing electrodes RE may be arranged on the second touch insulating layer TINS2. Each of the driving electrodes TE and the sensing electrodes RE may be a single layer or a multilayer made of any one or more selected from among molybdenum (Mo), aluminum (Al), chromium (Cr), gold (Au), titanium (Ti), nickel (Ni), neodymium (Nd), copper (Cu), and alloys thereof.

The driving electrodes TE and the sensing electrodes RE may overlap their corresponding connection electrodes BE in the third direction DR3. Each of the driving electrodes TE may be connected to a corresponding connection electrode BE through a touch contact hole TCNT1 penetrating the second touch insulating layer TINS2.

The third touch insulating layer TINS3 may be formed on the driving electrodes TE and the sensing electrodes RE. The third touch insulating layer TINS3 may serve to flatten steps formed by the driving electrodes TE, the sensing electrodes RE, and the connection electrodes BE. The third touch insulating layer TINS3 may be made of an organic layer such as an acryl resin, an epoxy resin, a phenolic resin, a polyamide resin, or a polyimide resin.

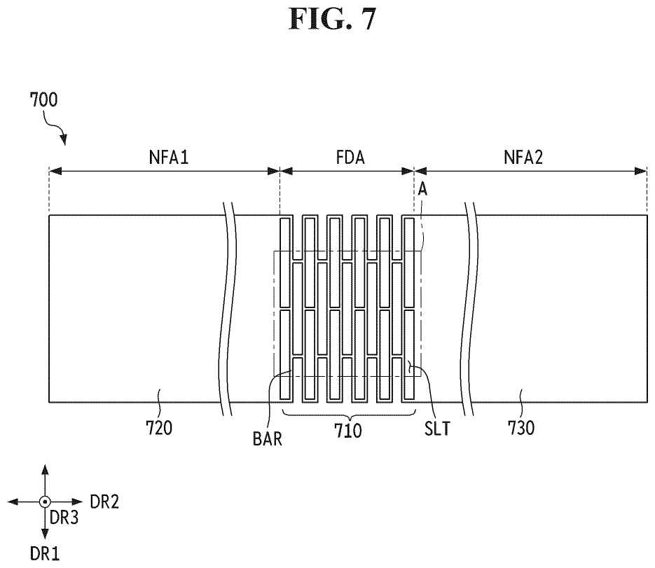

FIG. 7 is a plan view of a panel support member 700 according to one or more embodiments of the present disclosure.

Referring to FIG. 7, the panel support member 700 may include a folding portion 710, a first non-folding portion 720, and a second non-folding portion 730. The folding portion 710 may be arranged in the folding area FDA, the first non-folding portion 720 may be arranged in the first non-folding area NFA1, and the second non-folding portion 730 may be arranged in the second non-folding area NFA2. The folding area FDA may be an area where a grid pattern of the folding portion 710 is arranged, and the first and second non-folding areas NFA1 and NFA2 may be areas where a grid pattern is not arranged.

The folding portion 710 may be a portion that is folded if (e.g., when) the display device 10 is folded. In one or more embodiments, the folding portion 710 may be arranged between the first non-folding portion 720 and the second non-folding portion 730 in the second direction DR2.

The first non-folding portion 720 and the second non-folding portion 730 may be portions that are not folded if (e.g., when) the display device 10 is folded. The first non-folding portion 720 may be arranged on one side of the folding portion 710 in the second direction DR2, and the second non-folding portion 730 may be arranged on the other side of the folding portion 710 in the second direction DR2.

The folding portion 710 may include a grid pattern. For example, the folding portion 710 may include a plurality of bars BAR and a plurality of slits SLT arranged between (e.g., each respectively arranged between) the bars BAR.

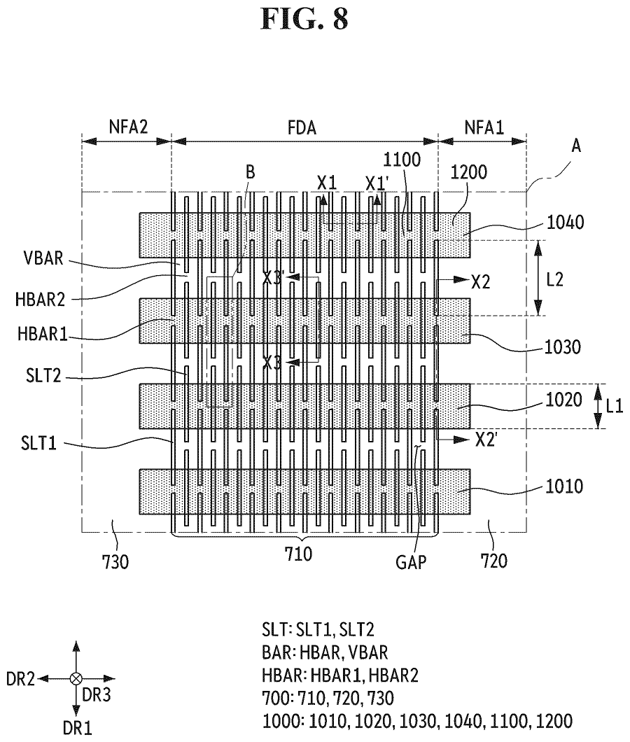

The bars BAR may include a plurality of horizontal bars HBAR (see FIG. 8) extending in the second direction DR2 and a plurality of vertical bars VBAR (see FIG. 8) extending in the first direction DR1. The bars BAR of the folding portion 710 may be seamlessly connected to each other and may seamlessly connect the first non-folding portion 720 and the second non-folding portion 730.

The slits SLT may be holes penetrating the panel support member 700 in the third direction DR3. The slits SLT may extend in the first direction DR1. For example, a length of each of the slits SLT in the first direction DR1 may be greater than a length of each of the slits SLT in the second direction DR2. The folding portion 710 may have flexibility by including the slits SLT. For example, the folding portion 710 may be stretched in the second direction DR2 if (e.g., when) the display device 10 is folded.

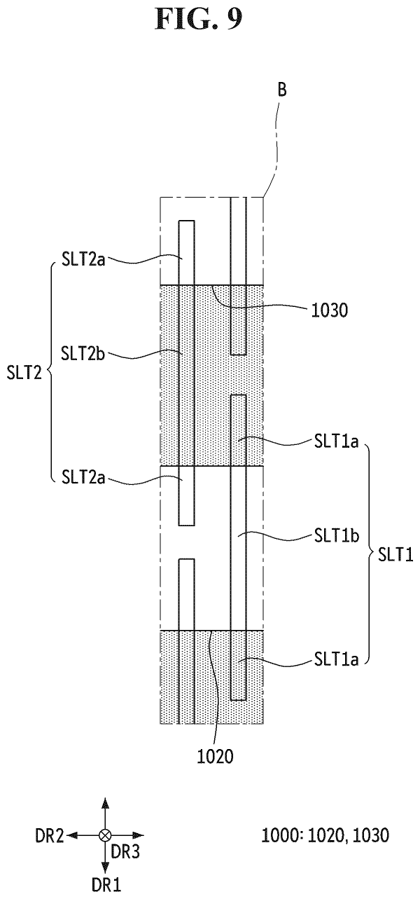

FIG. 8 is a rear view illustrating the panel support member 700 and the step member 1000 according to an embodiment in part A of FIG. 7. FIG. 9 is an enlarged view of part B of FIG. 8 according to one or more embodiments. FIG. 8 is a rear view illustrating a state where the step member 1000 is arranged on a back surface of the panel support member 700.

Referring to FIGS. 8 and 9 in addition to FIGS. 5 and 7, the slits SLT may include first slits SLT1 arranged in odd-numbered columns and second slits SLT2 arranged in even-numbered columns. The first slits SLT1 and the second slits SLT2 may be arranged alternately in the second direction DR2.

The bars BAR may include horizontal bars HBAR arranged between the first slits SLT1 or between the second slits SLT2 in the first direction DR1 and vertical bars VBAR arranged between the first slits SLT1 and the second slits SLT2 in the second direction DR2. The horizontal bars HBAR may include first horizontal bars HBAR1 arranged between the first slits SLT1 in the first direction DR1 and second horizontal bars HBAR2 arranged between the second slits SLT2 in the first direction DR1.

The first slits SLT1 and the second slits SLT2 may be staggered in the first direction DR1. For example, in one or more embodiments, both ends of the first slits SLT1 in the first direction DR1 may be adjacent to approximately central portions of the second slits SLT2 in the second direction DR2. Similarly, the first horizontal bars HBAR1 and the second horizontal bars HBAR2 may be staggered in the first direction DR1. The first horizontal bars HBAR1 and the second horizontal bars HBAR2 may not overlap each other in the second direction DR2.

The step member 1000 may be arranged on the back surface of the panel support member 700. The step member 1000 may serve as a spacer that forms a space between the panel support member 700 and the elastic member 600. The step member 1000 may be formed by a method such as plating or deposition or may be formed by attaching a support member.

The step member 1000 may include step portions 1100 overlapping the folding portion 710 and support portions 1200 overlapping the non-folding portions 720 and 730.

The step portions 1100 may overlap the folding portion 710 in the third direction DR3. The step portions 1100 may not overlap at least a portion of each of the slits SLT. For example, the step portions 1100 may or may not overlap a portion of each of the slits SLT. Each of the slits SLT may include at least a portion that does not overlap a (e.g., any) step portion 1100.

For example, as illustrated in FIG. 9, each of the first slits SLT1 may overlap a step pattern of the step member 1000 at at least one end SLT1a and may not overlap the step pattern of the step member 1000 at a central portion SLT1b. In addition, each of the second slits SLT2 may not overlap a step pattern of the step member 1000 at at least one end SLT2a and may overlap the step pattern of the step member 1000 at a central portion SLT2b.

The support portions 1200 may overlap the non-folding portions 720 and 730 in the third direction DR3. The step member 1000 may be securely supported on the back surface of the panel support member 700 by including the support portions 1200.

The step member 1000 may include a plurality of step patterns spaced apart from each other. The step patterns may include a first step pattern 1010, a second step pattern 1020, a third step pattern 1030, and a fourth step pattern 1040. The number of step patterns is not limited to that illustrated in the drawings.

In one or more embodiments, the first through fourth step patterns 1010, 1020, 1030, and 1040 may extend in a direction different from the direction in which the slits SLT extend. The first through fourth step patterns 1010, 1020, 1030, and 1040 may be spaced apart from each other in substantially the same direction as the direction in which the slits SLT extend. For example, in one or more embodiments, the first through fourth step patterns 1010, 1020, 1030, and 1040 may extend in the second direction DR2 and may be spaced apart from each other in the first direction DR1.

In one or more embodiments, the first through fourth step patterns 1010, 1020, 1030, and 1040 may overlap the first horizontal bars HBAR1 and may not overlap the second horizontal bars HBAR2. However, embodiments of the present disclosure are not limited thereto, for example, in one or more embodiments, the first through fourth step patterns 1010, 1020, 1030, and 1040 may not overlap the first horizontal bars HBAR1 and may overlap the second horizontal bars HBAR2.

A length (or width) L1 of each of the first through fourth step patterns 1010, 1020, 1030, and 1040 in the first direction DR1 may be smaller than a length L2 of each of the slits SLT in the first direction DR1. For example, the length L1 of a short side of each of the first through fourth step patterns 1010, 1020, 1030, and 1040 may be smaller than the length L2 of each of the slits SLT in the direction in which the slits SLT extend. Accordingly, each of the slits SLT may include at least a portion that does not overlap the step patterns of the step member 1000.

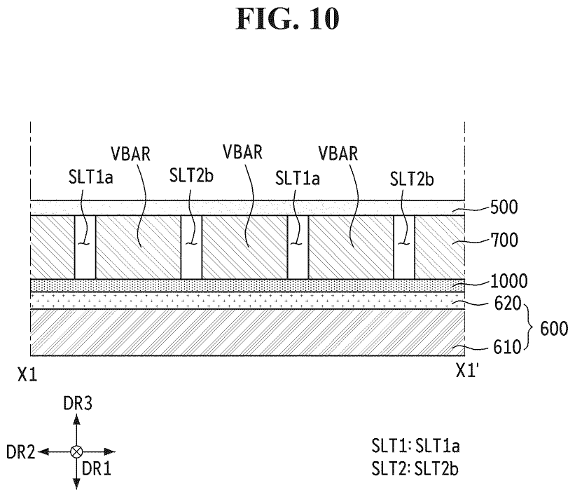

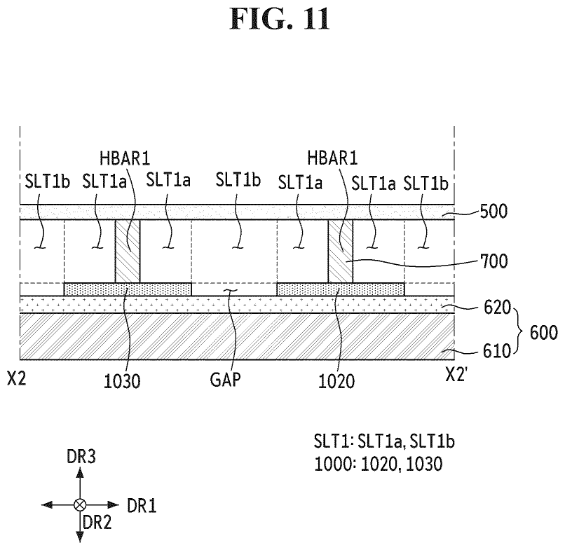

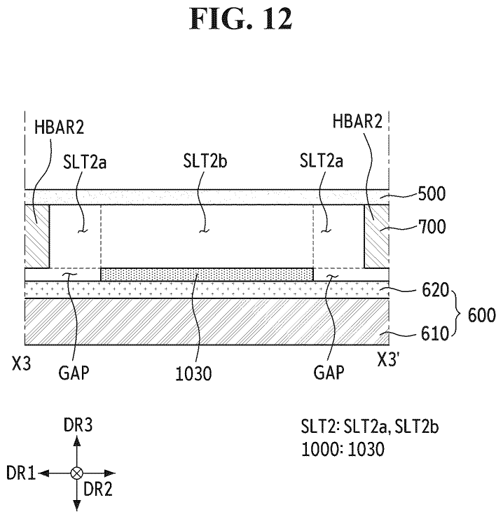

FIG. 10 is a cross-sectional view taken along the line X1-X1′ of FIG. 8 according to one or more embodiments. FIG. 11 is a cross-sectional view taken along the line X2-X2′ of FIG. 8 according to one or more embodiments. FIG. 12 is a cross-sectional view taken along the line X3-X3′ of FIG. 8 according to one or more embodiments. FIGS. 10 through 12 each illustrate a cross section of the second adhesive member 500, the panel support member 700, the step member 1000, and the elastic member 600.

Referring to FIGS. 10 through 12 in addition to FIGS. 5 and 7 through 9, in one or more embodiments, the elastic member 600 may include an elastic layer 610 and an adhesive layer 620 arranged on the elastic layer 610.

The elastic layer 610 may include an elastic material such as thermoplastic polyurethane (TPU). The adhesive layer 620 may include an adhesive material such as a pressure sensitive adhesive, an optically clear adhesive (OCA), or an acrylic adhesive. The adhesive layer 620 may bond the step member 1000 and the elastic member 600 or bond the panel support member 700 and the elastic member 600.

The second adhesive member 500 may be arranged on a front surface of the panel support member 700. The elastic member 600 may be arranged on the back surface of the panel support member 700. The step member 1000 may be arranged between the panel support member 700 and the elastic member 600.

As illustrated in FIGS. 10 through 12, the second adhesive member 500 may cover the entire front surface of the panel support member 700 to overlap all of the slits SLT. The elastic member 600 may cover the entire back surface of the panel support member 700 within an area overlapping the folding portion 710 to overlap all of the slits SLT.

In the display device 10 according to one or more embodiments, because the second adhesive member 500 covers the entire front surface of the panel support member 700 to overlap all of the slits SLT, the durability of the display device 10 in the folding area FDA may be improved.

In addition, in the display device 10 according to one or more embodiments, because the elastic member 600 covers the entire back surface of the panel support member 700 in the area overlapping the folding portion 710 to overlap all of the slits SLT, the durability of the display device 10 in the folding area FDA may be improved, and the penetration of foreign substances may be prevented or reduced.

FIG. 10 illustrates a cross section, taken along the second direction DR2, of a portion where a step pattern of the step member 1000 overlaps both (e.g., simultaneously) the first slits SLT1 and the second slits SLT2. For example, the step pattern of the step member 1000 may overlap at least one end SLT1a of each of the first slits SLT1 and may overlap the central portions SLT2b of the second slits SLT2.

FIG. 11 illustrates a cross section, taken along the first direction DR1, of a portion where step patterns of the step member 1000 overlap the first slits SLT1. For example, the step patterns of the step member 1000 may overlap at least one end SLT1a of each of the first slits SLT1 and may not overlap the central portions SLT1b of the first slits SLT1.

Similarly, FIG. 12 illustrates a cross section, taken along the first direction DR1, of a portion where a step pattern of the step member 1000 overlaps the second slits SLT2. For example, the step pattern of the step member 1000 may not overlap at least one end SLT2a of each of the second slits SLT2 and may overlap the central portions SLT2b of the second slits SLT2.

Because the step patterns of the step member 1000 are spaced apart from each other along the first direction DR1, a gap GAP may be formed between the panel support member 700 and the elastic member 600 in the third direction DR3 by a space between the step patterns. For example, as illustrated in FIG. 11, the gap GAP may be arranged in a space between the second step pattern 1020 and the third step pattern 1030.

The gap GAP may be connected to a plurality of slits SLT. For example, the gap GAP may be connected to the first slits SLT1 as illustrated in FIG. 11 and may be connected to the second slits SLT2 as illustrated in FIG. 12.

As illustrated in FIG. 8, the gap GAP may extend in the second direction DR2 from the step portions 1100 toward the support portions 1200, that is, from the folding area FDA toward the non-folding areas NFA1 and NFA2. Because the gap GAP is connected to the slits SLT and is open toward the non-folding areas NFA1 and NFA2, the inside of the slits SLT may be connected to the outside.

If the step member 1000 is not arranged, the elastic member 600 may cover the entire back surface of the panel support member 700 within the area overlapping the folding portion 710. Therefore, the slits SLT may be sealed by the second adhesive member 500 and the elastic member 600. In this regard, if (e.g., when) the display panel 400 is bonded to the panel support member 700, creases may occur in the display panel 400, the second adhesive member 500, and/or the elastic member 600 due to a difference in atmospheric pressure between the inside and outside of the sealed slits SLT.

In contrast, because the display device 10 according to one or more embodiments includes the step member 1000, a passage (e.g., an air path) may be secured so that the slits SLT are not sealed. Therefore, creases may be minimized or reduced in the display device 10.

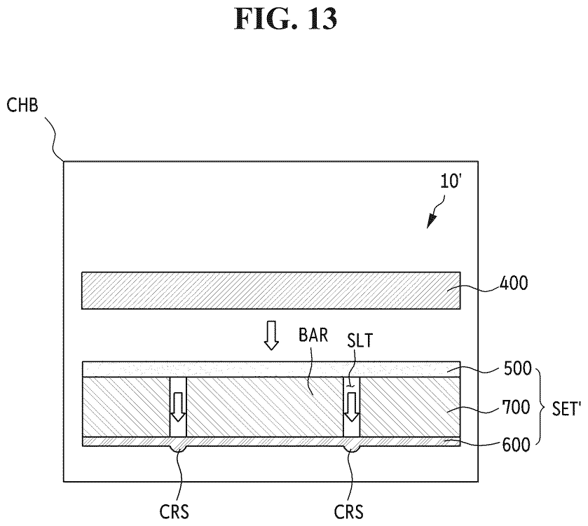

This will be further described in more detail with reference to FIGS. 13 through 18.

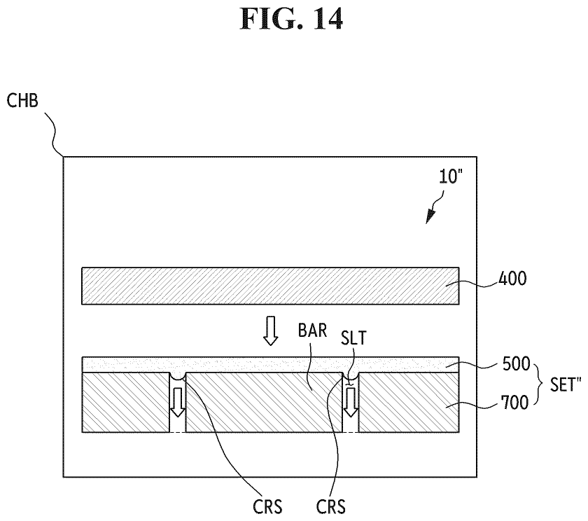

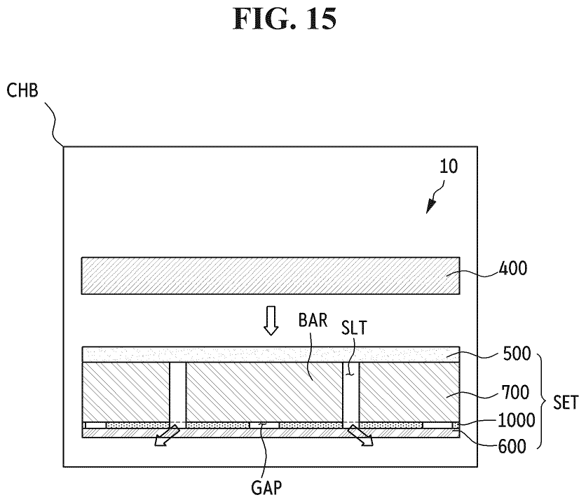

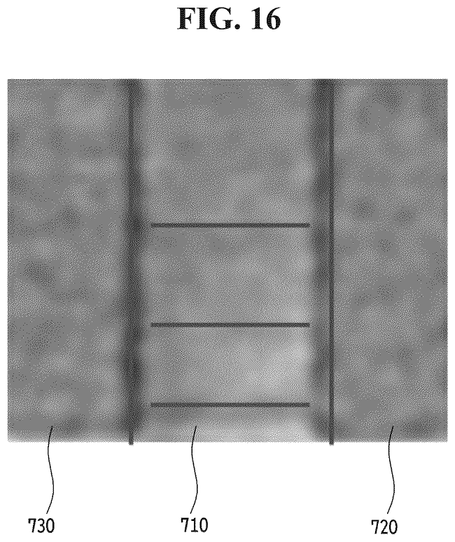

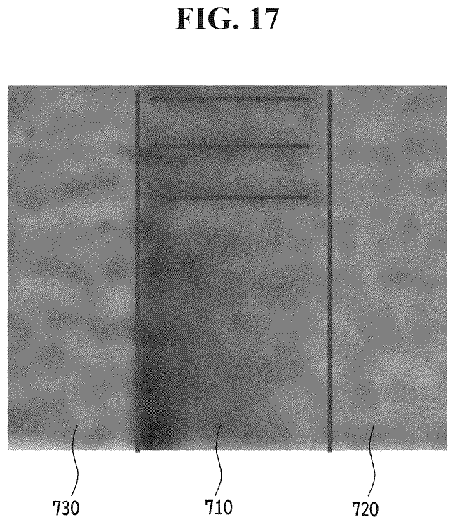

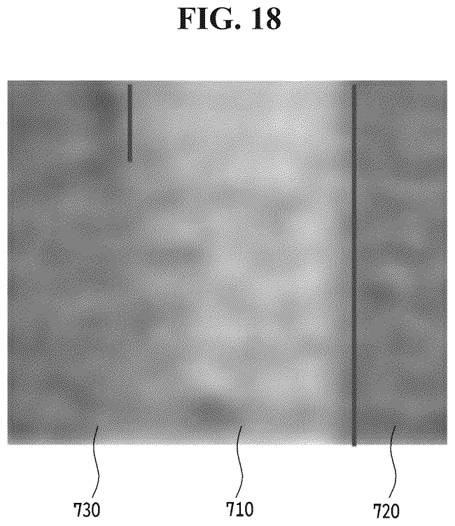

FIG. 13 is a cross-sectional view illustrating a process of bonding a display panel 400 to a set member SET′ in a process of manufacturing a display device 10′ according to a first comparative example of the present disclosure. FIG. 14 is a cross-sectional view illustrating a process of bonding a display panel 400 to a set member SET″ in a process of manufacturing a display device 10″ according to a second comparative example of the present disclosure. FIG. 15 is a cross-sectional view illustrating a process of bonding the display panel 400 to a set member SET in a process of manufacturing the display device 10 according to one or more embodiments of the present disclosure. FIG. 16 is an image of a folding portion 710 of the display device 10′ according to the first comparative example. FIG. 17 is an image of a folding portion 710 of the display device 10″ according to the second comparative example. FIG. 18 is an image of the folding portion 710 of the display device 10 according to one or more embodiments of the present disclosure.

Referring to FIGS. 13 through 18 in addition to FIGS. 8 through 12, the display device 10′ according to the first comparative example, the display device 10″ according to the second comparative example, and the display device 10 according to one or more embodiments may include the set members SET′, SET″, and SET, respectively.

As illustrated in FIG. 13, the display device 10′ according to the first comparative example may not include (e.g., may exclude) a step member 1000. For example, the set member SET′ of the display device 10′ according to the first comparative example may include a second adhesive member 500, a panel support member 700, and an elastic member 600. Accordingly, upper and lower portions of a plurality of slits SLT of the panel support member 700 may be sealed by the second adhesive member 500 and the elastic member 600, respectively.

As illustrated in FIG. 14, the display device 10″ according to the second comparative example may not include (e.g., may exclude) a step member 1000 and an elastic member 600. For example, the set member SET″ of the display device 10″ according to the second comparative example may include a second adhesive member 500 and a panel support member 700. Accordingly, upper portions of a plurality of slits SLT of the panel support member 700 may be covered by the second adhesive member 500, and lower portions of the slits SLT may be open.

As illustrated in FIG. 15, the display device 10 according to one or more embodiments may include both (e.g., simultaneously) the step member 1000 and the elastic member 600. For example, the set member SET of the display device 10 according to one or more embodiments may include the second adhesive member 500, the panel support member 700, the step member 1000, and the elastic member 600. Accordingly, upper and lower portions of a plurality of slits SLT of the panel support member 700 may be covered by the second adhesive member 500 and the elastic member 600, respectively. However, because gaps GAP are arranged under the slits SLT, the lower portions of the slits SLT may be open.

As illustrated in FIGS. 13 through 15, the process of bonding the display panel 400 to the set member SET′, SET″ or SET may be performed within a vacuum chamber CHB.

The atmospheric pressure inside the sealed slits SLT of the display device 10′ according to the first comparative example may be about 1 atmosphere (atm). As illustrated in FIG. 13, due to a difference between the atmospheric pressure inside the sealed slits SLT and the atmospheric pressure inside the vacuum chamber CHB, creases CRS may occur in the elastic member 600. Although not illustrated in the drawing, the creases CRS may also occur in the second adhesive member 500 of FIG. 13, as in the second adhesive member 500 of FIG. 14.

The lower portions of the slits SLT of the display device 10″ according to the second comparative example may be completely open. As illustrated in FIG. 14, due to the pressure applied to the second adhesive member 500 in the process of attaching the display panel 400, the creases CRS may occur in the second adhesive member 500.

The gaps GAP may be arranged under the slits SLT of the display device 10 according to one or more embodiments. As illustrated in FIG. 15, due to a buffering action of the gaps GAP, the creases CRS may not occur in the second adhesive member 500 and the elastic member 600. For example, as described above with reference to FIGS. 11 and 12, the step patterns of the step member 1000 partially overlap and partially do not overlap the slits SLT. Therefore, the speed and pressure of an air current escaping from the inside of the slits SLT toward the vacuum chamber CHB may be controlled or selected, thus minimizing or reducing the deformation of the second adhesive member 500 and the elastic member 600.

As shown in FIGS. 16 and 17, the display devices 10′ and 10″ according to the first and second comparative examples each have creases extending vertically along a boundary between a first non-folding portion 720 and a folding portion 710 and a boundary between a second non-folding portion 730 and the folding portion 710 and creases extending horizontally from the first non-folding portion 720 to the second non-folding portion 730.

As shown in FIG. 18, the display device 10 according to one or more embodiments has less creases extending vertically along the boundary between the first non-folding portion 720 and the folding portion 710 and the boundary between the second non-folding portion 730 and the folding portion 710 compared with the display devices 10′ and 10″ according to the first and second comparative examples and hardly has creases extending horizontally from the first non-folding portion 720 to the second non-folding portion 730.

Hereinafter, display devices according to other embodiments will be described. In the following embodiments, the same elements as those of the above-described embodiment will be indicated by the same reference numerals, and their redundant description will not be provided or given briefly, and differences will be mainly described.

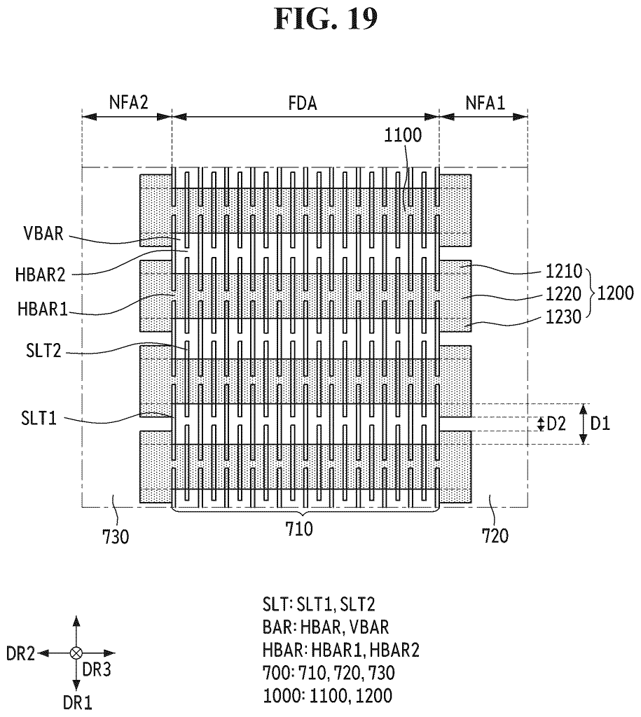

FIG. 19 is a rear view illustrating a panel support member 700 and a step member 1000 of a display device 10 according to one or more embodiments of the present disclosure.

Referring to FIG. 19, the display device 10 according to one or more embodiments is different from the display device 10 according to embodiments described above with reference to FIG. 8, and/or the like, in the planar shape of the step member 1000.

For example, a length of each support portion 1200 of the step member 1000 of the display device 10 according to one or more embodiments in the first direction DR1 may be greater than a length of each step portion 1100 in the first direction DR1.

For example, each support portion 1200 may include a first portion 1210, a second portion 1220, and a third portion 1230.

The second portion 1220 may be a portion overlapping a step portion 1100 in the second direction DR2. The first portion 1210 and the third portion 1230 may be portions not overlapping the step portion 1100 in the second direction DR2. The first portion 1210 may be located on one side of the second portion 1220 in the first direction DR1, and the third portion 1230 may be located on the other side of the second portion 1220 in the first direction DR1.

A distance D2 between the support portions 1200 adjacent to each other in the first direction DR1 may be smaller than a distance D1 between the step portions 1100 adjacent to each other in the first direction DR1.

As the area of each support portion 1200 of the display device 10 according to one or more embodiments increases, the step member 1000 may be supported more securely on a back surface of the panel support member 700. In addition, the amount and speed of air discharged from a folding area FDA to non-folding areas NFA1 and NFA2 may be controlled or selected by adjusting the distance D2 between the support portions 1200 adjacent to each other in the first direction DR1. Accordingly, creases CRS may be minimized or reduced in the folding area FDA of the display device 10.

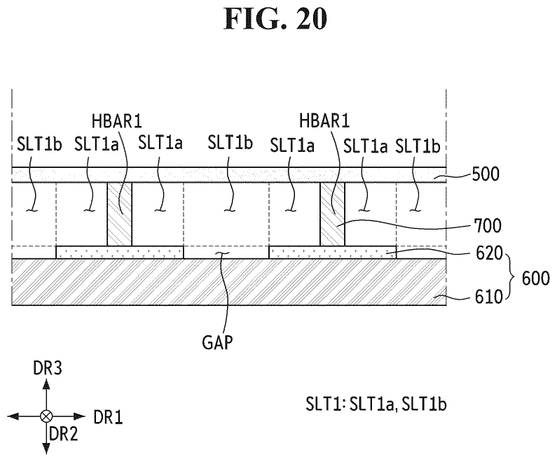

FIG. 20 is a cross-sectional view illustrating a second adhesive member 500, a panel support member 700, and an elastic member 600 of a display device 10 according to one or more embodiments.

Referring to FIG. 20, the display device 10 according to one or more embodiments is different from the display device 10 according to embodiments described above with reference to FIG. 11, and/or the like, in that it does not include a step member 1000, and an adhesive layer 620 includes step patterns and functions as a step member.

For example, the display device 10 according to one or more embodiments may not include (e.g., may exclude) the step member 1000. Therefore, the elastic member 600 may be directly arranged on a back surface of the panel support member 700. For example, an adhesive layer 620 of the elastic member 600 may directly contact the back surface of the panel support member 700.

In the display device 10 according to one or more embodiments, the adhesive layer 620 of the elastic member 600 may serve as a spacer that forms a space between the panel support member 700 and an elastic layer 610.

Like the step member 1000 of the display device 10 according to embodiments described above with reference to FIG. 11, and/or the like, the adhesive layer 620 may include step portions overlapping a folding portion 710 and support portions overlapping non-folding portions 720 and 730.

As illustrated in FIG. 20, each first slit SLT1 may overlap a step pattern of the adhesive layer 620 at at least one end SLT1a and may not overlap the step pattern of the adhesive layer 620 at a central portion SLT1b. Although not illustrated in the drawing, each second slit SLT2 may also not overlap a step pattern of the adhesive layer 620 at at least one end SLT2a and may overlap the step pattern of the adhesive layer 620 at a central portion SLT2b.

For example, the adhesive layer 620 according to one or more embodiments may have similar planar and cross-sectional shapes to the step member 1000 of the display device 10 according to embodiments described with reference to FIG. 11, and/or the like. The step portions and the support portions of the adhesive layer 620 according to one or more embodiments may have substantially the same shape and perform the same function as the step portions 1100 and the support portions 1200 of the step member 1000 of the display device 10 according to embodiments described with reference to FIG. 11, and/or the like.

Because a plurality of step patterns of the adhesive layer 620 are spaced apart from each other along the first direction DR1, a gap GAP may be formed between the panel support member 700 and the elastic layer 610 in the third direction DR3 by a space between the step patterns.

The gap GAP may be connected to a plurality of slits SLT. For example, the gap GAP may be connected to the first slits SLT1 as illustrated in FIG. 20 and may also be connected to the second slits SLT2, although not illustrated in the drawing.

Because the display device 10 according to one or more embodiments includes the adhesive layer 620 including the step patterns, a passage (e.g., an air path) may be formed so that the slits SLT are not sealed. Therefore, creases may be minimized or reduced in the display device 10.

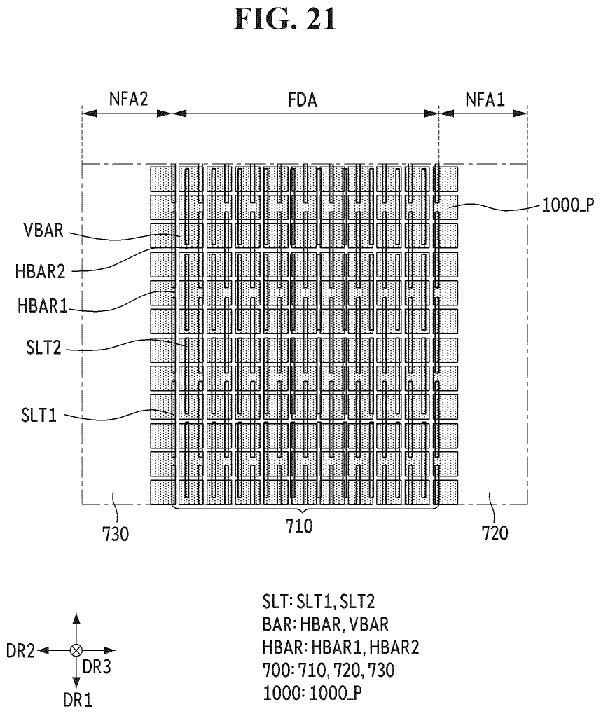

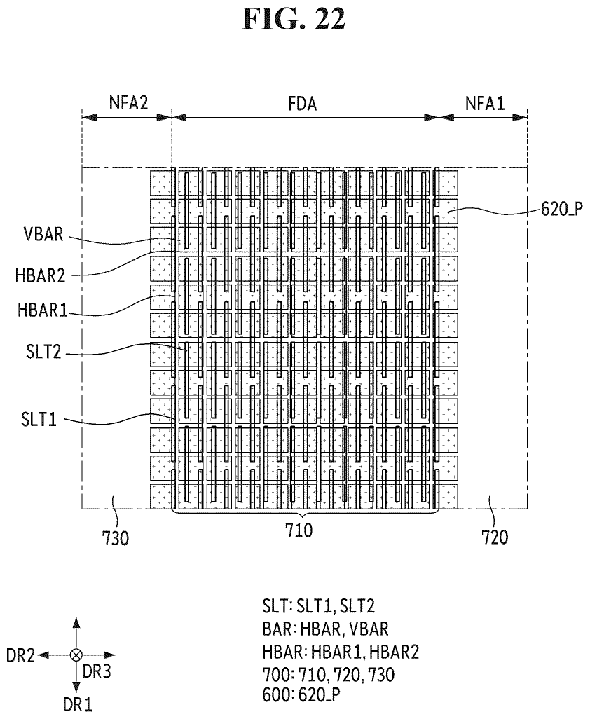

FIG. 21 is a rear view illustrating a panel support member 700 and a step member 1000 of a display device 10 according to one or more embodiments of the present disclosure. FIG. 22 is a rear view illustrating a panel support member 700 and an adhesive layer 620 of a step member of a display device 10 according to one or more embodiments of the present disclosure.

Referring to FIGS. 21 and 22, the display devices 10 according to one or more embodiments are different from the display devices 10 according to embodiments described above with reference to FIGS. 8, 19 and 20 in the planar shape of step patterns.

For example, while the step patterns illustrated in FIGS. 8 and 19 are line-type (kind) patterns extending in the first direction DR1, step patterns 1000_P and 620_P of the display devices 10 according to one or more embodiments may be island-type (kind) patterns. Here, island-type patterns refer to discrete, localized structures that are not continuous in any direction, unlike line-type or stripe-type patterns which extend linearly. These island-type patterns may be arranged in a grid or scattered configuration and may provide localized optical or structural effects, such as enhancing light extraction or mechanical feasibility, depending on their placement and geometry.

For example, FIG. 21 illustrates an embodiment in which the step member 1000 includes the step patterns 1000_P, and FIG. 22 illustrates an embodiment in which the adhesive layer 620 includes the step patterns 620_P.

As illustrated in FIGS. 21 and 22, the step patterns 1000_P may be spaced and/or apart (e.g., spaced apart) in the first direction DR1 and the second direction DR2 and may be arranged side by side with each other. The step patterns 620_P may be spaced and/or apart (e.g., spaced apart) in the first direction DR1 and the second direction DR2 and may be arranged side by side with each other. A plurality of slits SLT may each overlap spaces between the step patterns 1000_P in the third direction DR3. A plurality of slits SLT may each overlap spaces between the step patterns 620_P in the third direction DR3. For example, the step patterns 1000_P may not overlap at least a portion of each of the slits SLT. The step patterns 620_P may not overlap at least a portion of each of the slits SLT.

In one or more embodiments, the step patterns 1000_P and 620_P are each square in plan view. However, embodiments of the present disclosure are not limited thereto, and the step patterns 1000_P and 620_P may each have a shape such as a circle, an ellipse, or other polygons in plan view.

In one or more embodiments, the step patterns 1000_P may be arranged in a matrix direction in the first direction DR1 and the second direction DR2, and the step patterns 620_P are arranged in a matrix direction in the first direction DR1 and the second direction DR2. However, embodiments of the present disclosure are not limited thereto. For example, in one or more embodiments, the step patterns 1000_P and the step patterns 620_P may also be arranged in a diamond pattern along a diagonal direction different from the first direction DR1 and the second direction DR2 or may be arranged in an aperiodic or irregular pattern. For example, the step patterns 1000_P and 620_P may be arranged in a matrix configuration along the first direction DR1 and the second direction DR2, forming a regular grid-like structure. However, the present disclosure is not limited to this arrangement. In alternative embodiments, the step patterns may be arranged in a diamond configuration, aligned along diagonal directions that differ from DR1 and DR2, or in aperiodic or irregular patterns. These alternative layouts may be tailored to optimize mechanical flexibility, stress distribution, or visual uniformity depending on the specific design requirements of the folding display. The ability to vary the spatial arrangement of the step patterns provides additional design freedom to enhance performance characteristics such as foldability, durability, and/or visual consistency.

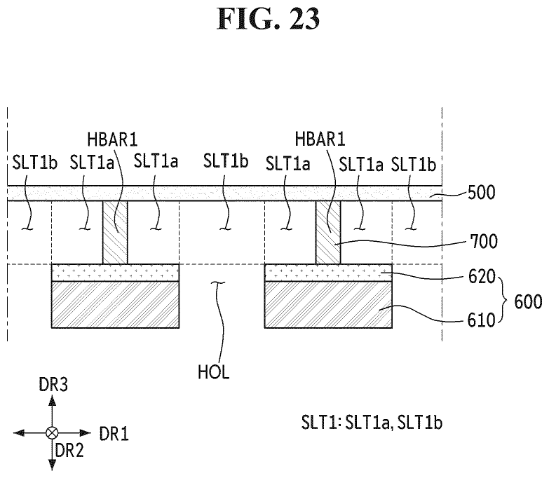

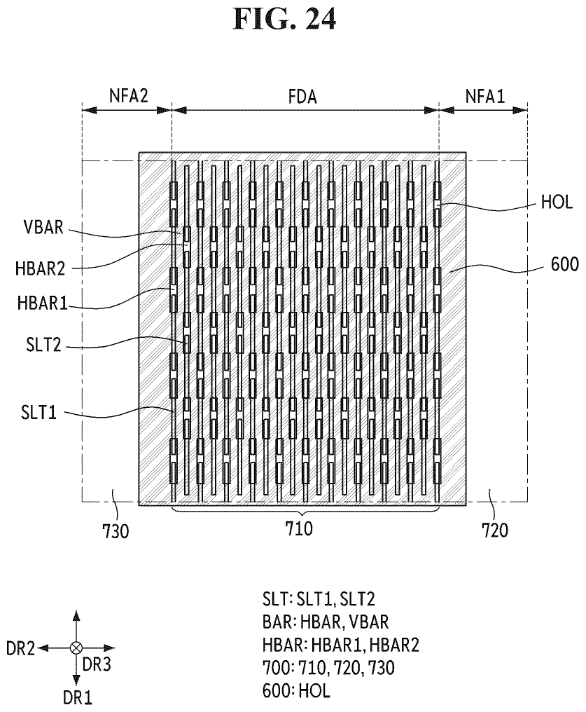

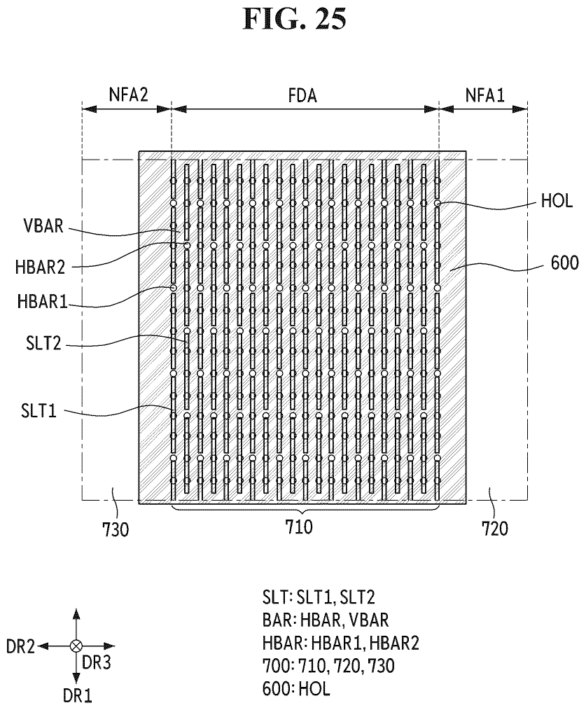

FIG. 23 is a cross-sectional view illustrating a second adhesive member 500, a panel support member 700, and an elastic member 600 of a display device 10 according to one or more embodiments of the present disclosure. FIG. 24 is a rear view illustrating an example of the panel support member 700 and the elastic member 600 of the display device 10 according to embodiments of FIG. 23. FIG. 25 is a rear view illustrating an example of the panel support member 700 and the elastic member 600 of the display device 10 according to embodiments of FIG. 23.

Referring to FIGS. 23 through 25, the display device 10 according to one or more embodiments is different from the display devices 10 according to embodiments described above with reference to FIGS. 8 and 19 through 21 in that the elastic member 600 includes holes HOL.

For example, the elastic member 600 of the display device 10 according to one or more embodiments may include a plurality of holes HOL penetrating an elastic layer 610 and an adhesive layer 620.

The holes HOL may overlap a folding portion 710 in the third direction DR3. The holes HOL may overlap at least a portion of each of a plurality of slits SLT.

For example, in one or more embodiments, as illustrated in FIG. 23, each first slit SLT1 may not overlap a hole HOL of the elastic member 600 at at least one end SLT1a and may overlap the hole HOL of the elastic member 600 at a central portion SLT1b. In addition, although not illustrated in the drawing, each second slit SLT2 may overlap a hole HOL of the elastic member 600 at at least one end and may not overlap the hole HOL of the elastic member 600 at a central portion.

For example, in one or more embodiments, as illustrated in FIG. 24, each first slit SLT1 may overlap a hole HOL of the elastic member 600 at at least one end and may not overlap the hole HOL of the elastic member 600 at a central portion. In addition, each second slit SLT2 may overlap a hole HOL of the elastic member 600 at at least one end and may not overlap the hole HOL of the elastic member 600 at a central portion.

For example, in one or more embodiments, as illustrated in FIG. 25, each of the first and second slits SLT1 and SLT2 may overlap holes HOL of the elastic member 600 at two or more portions spaced apart from each other.

In one or more embodiments, as illustrated in FIG. 24, the holes HOL of the elastic member 600 may extend in substantially the same direction as the slits SLT. For example, the holes HOL of the elastic member 600 may extend in the first direction DR1 in which the slits SLT extend. For example, the holes HOL of the elastic member 600 may be line-type (kind) patterns.

A length of each of the holes HOL of the elastic member 600 in the first direction DR1 may be smaller than a length of each of the slits SLT in the first direction DR1. Among the holes HOL of the elastic member 600, holes HOL overlapping the first slits SLT1 may overlap first horizontal bars HBAR1. Among the holes HOL of the elastic member 600, holes HOL overlapping the second slits SLT2 may overlap second horizontal bars HBAR2.

The holes HOL overlapping the first slits SLT1 among the holes HOL of the elastic member 600 may be arranged alternately in the second direction DR2 with the holes HOL overlapping the second slits SLT2 among the holes HOL of the elastic member 600. The holes HOL overlapping the first slits SLT1 among the holes HOL of the elastic member 600 may be staggered in the first direction DR1 with the holes HOL overlapping the second slits SLT2 among the holes HOL of the elastic member 600.

In one or more embodiments, as illustrated in FIG. 25, the holes HOL of the elastic member 600 may be island-type (kind) patterns. For example, these island-type patterns refer to discrete, non-continuous hole arrangements, as opposed to line-type or stripe-type patterns that extend in a linear direction. The holes HOL of the elastic member 600 may be spaced and/or apart from each other in the first direction DR1 and the second direction DR2 and may be arranged side by side with each other. The holes HOL of the elastic member 600 may at least partially overlap the slits SLT.

In one or more embodiments, as illustrated in FIG. 25, the holes HOL of the elastic member 600 are circular in plan view. However, embodiments of the present disclosure are not limited thereto, for example, in one or more embodiments, the holes HOL of the elastic member 600 may each have a shape such as an ellipse or other polygons in plan view.

In one or more embodiments, as illustrated in FIG. 25, the holes HOL of the elastic member 600 are arranged in a matrix direction in the first direction DR1 and the second direction DR2. However, embodiments of the present disclosure are not limited thereto. For example, in one or more embodiments, the holes HOL of the elastic member 600 may be arranged in a diamond pattern along a diagonal direction different from the first direction DR1 and the second direction DR2 or may be arranged in an aperiodic or irregular pattern.

The display devices 10 according to the above-described embodiments may be applied to one or more suitable electronic devices. An electronic device according to one or more embodiments may include any one of the above-described display devices 10 and may further include modules or devices having other additional functions, in addition to the display device 10.

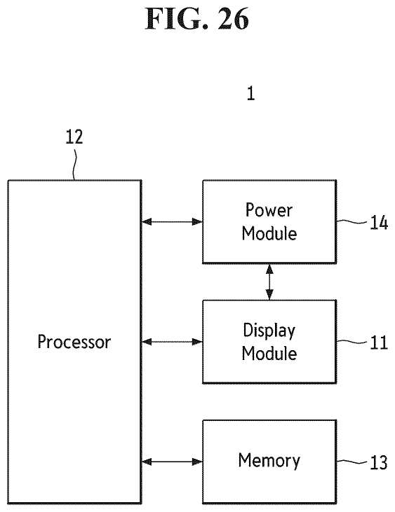

FIG. 26 is a block diagram of an electronic device 1 according to one or more embodiments of the present disclosure.

Referring to FIG. 26, the electronic device 1 according to one or more embodiments may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

The memory 13 may store data information necessary for an operation of the processor 12 and/or the display module 11. When the processor 12 executes an application stored in the memory 13, an image data signal and/or an input control signal may be transmitted to the display module 11, and the display module 11 may process the received signal and output image information through a display screen.

The power module 14 may include a power supply module such as a power adapter and/or a battery device and a power conversion module which generates power necessary for the operation of the electronic device 1 by converting power supplied by the power supply module.

At least one of the components of the electronic device 1 described above may be included in a display device 10 according to the embodiments described above. In addition, some of individual modules functionally included in one module may be included in the display device 10, and other modules may be provided separately from the display device 10. For example, the display device may include the display module 11, and the processor 12, the memory 13, and the power module 14 may be provided not in the display device 10 but in the form of other devices within the electronic device 1.

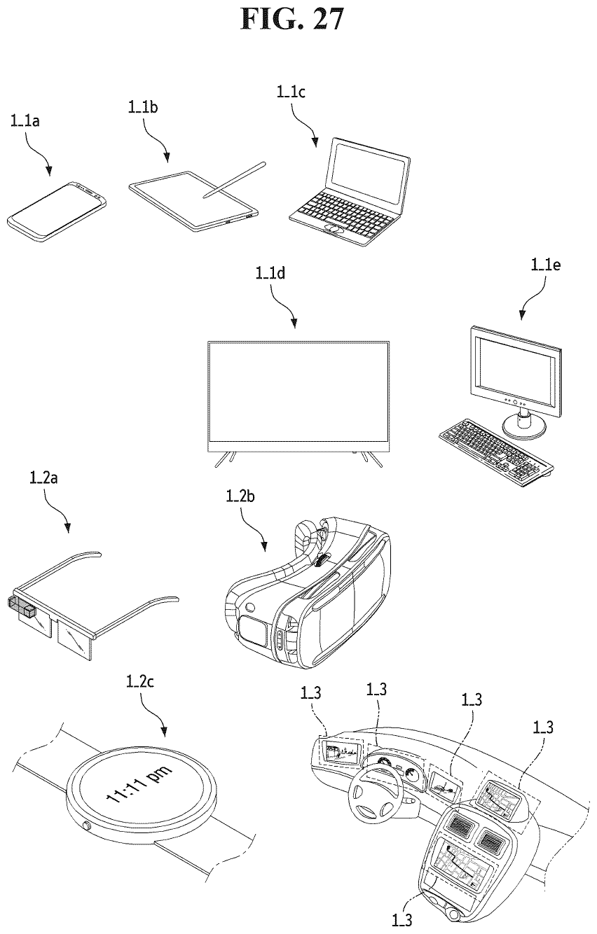

FIG. 27 is a schematic diagram of electronic devices according to one or more embodiments of the present disclosure.

Referring to FIG. 27, one or more suitable electronic devices 1 to which display devices 10 according to one or more embodiments are applied may include not only image display electronic devices 1 such as a smartphone 1_1a, a tablet PC 1_1b, a laptop 1_1c, a television 1_1d, and a desk monitor 1_1e, but also wearable electronic devices 1 including display modules, such as smart glasses 1_2a, a head mounted display 1_2b, and a smart watch 1_2c, and vehicle electronic devices 1_3 including display modules, such as a center information display (CID) and a room mirror display placed on an instrument panel, center fascia, and dashboard of a vehicle.

In the present disclosure, it will be understood that the terms “comprise(s)/comprising,” “include(s)/including,” or “have/has/having” specify the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having,” or other similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

As utilized herein, the singular forms “a,” “an,” “one,” and “the” are intended to include the plural forms as well, unless the context clearly indicates otherwise. Further, the use of “may” when describing embodiments of the present disclosure refers to “one or more embodiments of the present disclosure”.

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof.

In the context of the present application and unless otherwise defined, the terms “use,” “using,” and “used” may be considered synonymous with the terms “utilize,” “utilizing,” and “utilized,” respectively.

As utilized herein, the terms “substantially,” “about,” “approximately,” or similar terms are used as terms of approximation and not as terms of degree, and are intended to account for the inherent deviations in measured or calculated values that would be recognized by those of ordinary skill in the art. “About” or “approximately” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

The light emitting element, the display panel, the display device, the electronic device/apparatus, the device-manufacturing apparatus (e.g., step member-manufacturing apparatus), or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In concluding the detailed description, those skilled in the art will appreciate that many variations and modifications can be made to the example embodiments without substantially departing from the principles of the present disclosure. Therefore, the disclosed embodiments of the disclosure are used in a generic and descriptive sense only and not for purposes of limitation. It is further to be understood that the scope of the present disclosure is defined by the appended claims and equivalents thereof rather than the detailed description described above, and all modifications and alterations derived from the claims and their equivalents fall within the scope of the present disclosure.

What is claimed is:

1. A display device comprising:
a display panel comprising a folding area and a non-folding area on at least one side of the folding area;
a panel support member on the display panel and comprising a folding portion overlapping the folding area and a non-folding portion overlapping the non-folding area;
an adhesive member between the display panel and the panel support member;
an elastic member opposite the adhesive member with the panel support member interposed therebetween and overlapping the folding portion; and
a step member between the panel support member and the elastic member and overlapping the folding portion,
wherein
the folding portion comprises a plurality of slits and a plurality of bars between the slits,
the step member comprises a plurality of step patterns spaced from each other to form a space between the panel support member and the elastic member, and
the space at least partially overlaps the slits.

2. The display device of claim 1, wherein the step member comprises a step portion overlapping the folding portion and a support portion overlapping the non-folding portion.

3. The display device of claim 2, wherein a width of the support portion is greater than a width of the step portion.

4. The display device of claim 1, wherein
each of the slits comprises a first portion and a second portion on one side of the first portion,
the first portion overlaps the step patterns, and
the second portion does not overlap the step patterns.

5. The display device of claim 1, wherein
the slits comprise first slits and second slits parallel to each other in a first direction,
each of the first slits and the second slits comprises a first portion and a second portion on one side of the first portion,
the first slits and the second slits are staggered in a second direction different from the first direction, and
the step patterns:
overlap the first portions of the first slits and do not overlap the first portions of the second slits; and
do not overlap the second portions of the first slits and overlap the second portions of the second slits.

6. The display device of claim 1, wherein the step patterns extend in a different direction from the slits.

7. The display device of claim 6, wherein
each of the step patterns comprises long sides located in a direction which the step patterns extend and short sides connected to the long sides, and
a length of each of the short sides of the step patterns is smaller than a length of each of the slits in a direction in which the slits extend.

8. The display device of claim 1, wherein the step patterns are island-type patterns.

9. The display device of claim 1, wherein the space is connected to the slits.

10. The display device of claim 1, wherein the adhesive member overlaps the slits.

11. The display device of claim 1, wherein the step member is formed by plating or deposition.

12. A display device comprising:
a display panel comprising a folding area and a non-folding area on at least one side of the folding area;
a panel support member on the display panel and comprising a folding portion overlapping the folding area and a non-folding portion overlapping the non-folding area;
an adhesive member between the display panel and the panel support member; and
an elastic member opposite the adhesive member with the panel support member interposed therebetween and overlapping the folding portion,
wherein
the folding portion comprises a plurality of slits and a plurality of bars between the slits,
the elastic member comprises an elastic layer and an adhesive layer between the elastic layer and the panel support member,
the adhesive layer comprises a plurality of step patterns spaced from each other to form a space between the panel support member and the elastic layer, and
the space at least partially overlaps the slits.

13. The display device of claim 12, wherein
each of the slits comprises a first portion and a second portion on one side of the first portion,
the first portion overlaps the step patterns, and
the second portion does not overlap the step patterns.

14. The display device of claim 12, wherein the space is connected to the slits.

15. The display device of claim 12, wherein the adhesive member overlaps the slits.

16. An electronic device comprising a display device and a processor, wherein the display device comprises:
a display panel comprising a folding area and a non-folding area on at least one side of the folding area;
a panel support member on the display panel and comprising a folding portion overlapping the folding area and a non-folding portion overlapping the non-folding area;
an adhesive member between the display panel and the panel support member;
an elastic member opposite the adhesive member with the panel support member interposed therebetween and overlapping the folding portion; and
a step member between the panel support member and the elastic member and overlapping the folding portion,
wherein
the folding portion comprises a plurality of slits and a plurality of bars between the slits,
the step member comprises a plurality of step patterns spaced from each other to form a space between the panel support member and the elastic member, and
the space at least partially overlaps the slits.

17. The electronic device of claim 16, wherein
each of the slits comprises a first portion and a second portion on one side of the first portion,
the first portion overlaps the step patterns, and
the second portion does not overlap the step patterns.

18. The electronic device of claim 16, wherein
the slits comprise first slits and second slits parallel to each other in a first direction,
each of the first slits and the second slits comprises a first portion and a second portion on one side of the first portion,
the first slits and the second slits are staggered in a second direction different from the first direction, and
the step patterns:
overlap the first portions of the first slits and do not overlap the first portions of the second slits; and
do not overlap the second portions of the first slits and overlap the second portions of the second slits.

19. An electronic device comprising the display device of claim 12 and a processor.

20. The electronic device of claim 19, wherein
each of the slits comprises a first portion and a second portion on one side of the first portion,
the first portion overlaps the step patterns, and the second portion does not overlap the step patterns.
